(19) United States
(12) Patent Application Publication
(10) Pub. No.: US 2019/0105938 A1
(43) Pub. Date: Apr. 11, 2019

(54) SECURITY ELEMENTS AND METHOD OF MANUFACTURE THEREOF

(71) Applicant: DE LA RUE INTERNATIONAL LIMITED, Basingstoke, Hampshire (GB)

(72) Inventors: Brian William HOLMES, Fleet (GB); Navin SUYAL, Basingstoke (GB)

(73) Assignee: DE LA RUE INTERNATIONAL LIMITED, Basingstoke, Hampshire (GB)

(21) Appl. No.: 16/093,906

(22) PCT Filed: Apr. 26, 2017
(86) PCT No.: PCT/GB2017/051167

§ 371 Date: Oct. 15, 2018

(30) Foreign Application Priority Data
Apr. 29, 2016 (GB) 1607479.1

(51) Int. Cl. B42D 25/324; B42D 25/328; B42D 25/342; B42D 25/45; B42D 25/373; G02B 5/18; G02B 3/00

(52) U.S. Cl. CPC B42D 25/324; B42D 25/328; B42D 25/342; B42D 25/24; B42D 25/373; G02B 5/1861; G02B 3/0006; B42D 25/45

(57) ABSTRACT

A security element includes a first layer, the first layer having opposing first and second surfaces, and being formed of a substantially transparent first material having a first refractive index, the first surface of the first layer having formed therein, in a first region, an array of focussing elements. An optically variable effect generating structure is located over the first layer in a second region at least partially overlapping the array of focussing elements in the first region. An array of image elements is arranged over the array of focussing elements such that a first image, formed from at least some of the image elements, is displayed to a viewer viewing the image elements via the array of focussing elements of the first layer. The optically variable effect generating structure is also configured to display, in the second region, a second image to the viewer.

The present invention relates to security elements suitable for use in security documents such as banknotes, identity documents, passports, certificates and the like, as well as methods for manufacturing such security elements, and security documents bearing said security elements.

Articles of value, and particularly documents of value such as banknotes, cheques, passports, identification documents, certificates and licences, are frequently the target of counterfeiters and persons wishing to make fraudulent copies thereof and/or changes to any data contained therein. Typically such objects are provided with a number of visible security elements or security devices for checking the authenticity of the object. By “security element” we mean a feature which it is not possible to reproduce accurately by taking a visible light copy, e.g. through the use of widely available photocopying or scanning equipment.

One class of security elements are those which produce an optically variable effect, meaning that the appearance of the element is different at different angles of view. Such elements are particularly effective since direct copies (e.g. photocopies) will not produce the optically variable effect and hence can be readily distinguished from genuine devices.

A particular class of optically variable effect generating elements are those which make use of focussing elements such as lenses. These include moiré magnifier devices, integral imaging devices and so-called lenticular devices.

Moiré magnifier devices (examples of which are described in EP-A-1695121, WO-A-94/27254, WO-A-2011/107782 and WO2011/107783) make use of an array of focussing elements (such as lenses or mirrors) and a corresponding array of microimages, wherein the pitches of the focussing elements and the array of microimages and/or their relative locations are mismatched with the array of focussing elements such that a magnified version of the microimages is generated due to the moiré effect. Each microimage is a complete, miniature version of the image which is ultimately observed, and the array of focussing elements acts to select and magnify a small portion of each underlying microimage, which portions are combined by the human eye such that the whole, magnified image is visualised. This mechanism is sometimes referred to as “synthetic magnification”. The magnified array appears to move relative to the device upon tilting and can be configured to appear above or below the surface of the device itself. The degree of magnification depends, inter alia, on the degree of pitch mismatch and/or angular mismatch between the focussing element array and the microimage array.

Integral imaging devices are similar to moiré magnifier devices in that an array of microimages is provided under a corresponding array of lenses, each microimage being a miniature version of the image to be displayed. However here there is no mismatch between the lenses and the microimages. Instead a visual effect is created by arranging for each microimage to be a view of the same object but from a different viewpoint. When the device is tilted, different ones of the images are magnified by the lenses such that the impression of a three-dimensional image is given.

“Hybrid” devices also exist which combine features of moiré magnification devices with those of integral imaging devices. In a “pure” moiré magnification device, the microimages forming the array will generally be identical to one another. Likewise in a “pure” integral imaging device there will be no mismatch between the arrays, as described above. A “hybrid” moiré magnification/integral imaging device utilises an array of microimages which differ slightly from one another, showing different views of an object, as in an integral imaging device. However, as in a moiré magnification device there is a mismatch between the focussing element array and the microimage array, resulting in a synthetically magnified version of the microimage array, due to the moiré effect, the magnified microimages having a three-dimensional appearance. Since the visual effect is a result of the moiré effect, such hybrid devices are considered a subset of moiré magnification devices for the purposes of the present disclosure.

In general, therefore, the microimages provided in a moiré magnification device should be substantially identical in the sense that they are either exactly the same as one another (pure moiré magnifiers) or show the same object/scene but from different viewpoints (hybrid devices).

Moiré magnifiers, integral imaging devices and hybrid devices can all be configured to operate in just one dimension (e.g. utilising cylindrical lenses) or in two dimensions (e.g. comprising a 2D array of spherical or aspherical lenses).

Lenticular devices on the other hand do not rely upon magnification, synthetic or otherwise. An array of focussing elements, typically cylindrical lenses, overlies a corresponding array of image sections, or “slices”, each of which depicts only a portion of an image which is to be displayed. Image slices from two or more different images are interleaved and, when viewed through the focussing elements, at each viewing angle, only selected image slices will be directed towards the viewer. In this way, different composite images can be viewed at different angles. However it should be appreciated that no magnification typically takes place and the resulting image which is observed will be of substantially the same size as that to which the underlying image slices are formed. Some examples of lenticular devices are described in U.S. Pat. No. 4,892,336, WO-A-2011/051669, WO-A-2011051670, WO-A-2012/027779 and U.S. Pat. No. 6,856,462. More recently, two-dimensional lenticular devices have also been developed and examples of these are disclosed in British patent application numbers WO-A-2015011493 and WO-A-2015011494. Lenticular devices have the advantage that different images can be displayed at different viewing angles, giving rise to the possibility of animation and other striking visual effects which are not possible using the moiré magnifier or integral imaging techniques.

An example of a device which attempts to improve the security of elements that employ arrays of lenses to generate an optically variable effect may be found in US 2008/0160226 A1. This document discloses a lens based device which comprises a zero-order diffraction grating arranged over an array of absorbing microstructures. The interplay between the zero order diffraction grating and the absorbing microstructures generates a single image exhibiting two types of optical variation, i.e. the device displays a colour shifting moiré magnified image.

Aspects of the present invention provide improved security elements and methods of manufacture thereof, and in particular, provide improved security elements which use arrays of lenses to generate an optically variable effect.

A first aspect of the present invention provides a security element comprising: a first layer, the first layer having opposing first and second surfaces, and being formed of a substantially transparent first material having a first refractive index, the first surface of the first layer having formed therein, in a first region, an array of focussing elements; an optically variable effect generating structure located over the first layer in a second region at least partially overlapping the array of focussing elements in the first region; and an array of image elements arranged over the array of focussing elements such that a first image, formed from at least some of the image elements, is displayed to a viewer viewing the image elements via the array of focussing elements of the first layer; wherein the optically variable effect generating structure is configured to display, in the second region, a second image to the viewer.

By providing an array of focussing elements which cooperate with an array of image elements, and combining this with an overlapping optically variable effect generating structure and producing a second image, a more complex and visually striking optically variable effect can be obtained.

In accordance with a first variant, the optically variable effect generating structure is substantially transparent in the second region such that the first image is displayed in at least the region of the overlap of the first and second regions to a viewer viewing the image elements via both the array of focussing elements of the first layer and the optically variable effect generating structure, and such that the second image is displayed in the second region to the viewer viewing the image elements via both the array of focussing elements of the first layer and the optically variable effect generating structure, one of the first image and the second image being displayed to the viewer superimposed on the other in the region of the overlap of the first and second regions.

By providing an array of focussing elements which cooperate with an array of image elements, and combining this with a substantially transparent optically variable effect generating structure which overlaps the focussing elements and image elements and produces a second image, an even more complex and visually striking optically variable effect can be obtained. Whereas in known devices, effects such as the moiré effect and lenticular effect are observed by viewing image elements through a suitable array of focussing elements to produce a single optically variable image, these particularly preferable embodiments of the present invention provide an improved structure for viewing those image elements, which provides a second optically variable image in addition to the first, which is substantially independent of the image elements and focussing elements, with the two images appearing superimposed as a result of the overlap of the structures.

In an alternative variant, the first and second images are visible separately and simultaneously. This may be achieved, for example, by providing that the optically variable effect generating structure is substantially opaque in the second region, for example, owing to the presence of a metallic reflection enhancing layer in the optically variable effect generating structure. The result may be first and second images that are adjacent one another, with the second image being displayed in the second region and the first image being displayed in the first region where it is not overlapped by the second region. As an alternative to the opaque optically variable effect generating structure, the second image may be produced by, for example, a prism structure which exhibits total internal reflection (see for example WO 06095161 A1), which is itself not opaque but obscures the first image in the second region.

By providing an array of focussing elements which cooperate with an array of image elements, and combining this with a optically variable effect generating structure through which the first image is not visible, a complex visual appearance is achieved, which thereby improves the security of the element. In these embodiments, the viewer sees two different images which occupy the observed area and co-exist without appearing to overlap. By providing the observed area with these co-existing structures, interesting optical effects can be achieved as they can be differently configured, for example, leading to first and second images which react differently to tilting.

The first layer of security elements according to the present invention provides the array of focussing elements in a first region. The first layer is of a first material which is substantially transparent. The term substantially transparent is intended to cover any material which allows image formation in at least one wavelength using light which passes therethrough. In other words, a transparent material allows light of at least one wavelength to pass through without overwhelming absorption or scattering. It will be appreciated that a transparent material may appear clear, or may appear to carry a colour tint. A transparent material may also carry an optically effective substance, such as a visible colourant, or a luminescent, phosphorescent or fluorescent material. Such optically effective substances could be disposed in any one or more of the other transparent layers of the device, including the first layer, and second layer, optical spacer layers and/or reflection enhancing layers, which will be described below.

An optically variable effect generating structure is located over the first layer. The word ‘over’ is intended to cover any location of the optically variable effect generating structure either above or beneath the first layer, provided that there is some overlapping of the two layers with respect to one another. The word ‘over’ should not be considered to mean “directly on”, as in some embodiments one or more spacer layers may be located between the first layer and the optically variable effect generating structure. In some embodiments, the optically variable effect generating structure is substantially transparent in the second region, and again, substantially transparent is intended to mean that the structure allows image formation in at least one wavelength using light which passes therethrough. In other embodiments, the optically variable effect generating structure is substantially opaque, by which it is meant that the structure substantially prevents the transmission of light, e.g. by being reflective. The second region will at least partially overlap the first region; one region may lie entirely within the other, the regions may be identical, or there may be areas of both regions which exist outside of the overlap and do not overlap the other region.

An array of image elements is arranged over the array of focussing elements. The array of image elements will typically be provided across the entire first region, i.e. wherever focussing elements are provided. However, the effects of the invention can also be obtained where image elements are provided only in the region of the overlap of the first and second regions, such that the focussing elements produce the first image only in the second region. As explained above, the word ‘over’ is intended to cover any location of the image elements either above or beneath the focussing elements in the first layer, provided that there is some overlapping of the image elements and focussing elements such that a first image is generated by cooperation between the two. The image elements need not be on the same side of the first layer as the optically variable effect generating structure for both to be considered ‘over’ the first layer, and in many embodiments, the first layer is located between the optically variable effect generating structure and the image elements. Further, the word ‘over’ should not be considered to mean “directly on”, as in some embodiments one or more spacer layers may be located between the first layer and the image elements.

In accordance with the invention, the optically variable effect generating structure is configured to display a second image in the second region such that the first image displayed to the viewer viewing the image elements through the array of focussing elements of the first layer and the second image appear superimposed on one another, thereby producing a complex and visually striking optically variable effect. An ‘image’ in this context is intended to mean a marking, preferably taking the form of one or more characters such as alphanumerical text or numbers, symbols, logos, graphics or photographic images. The marking may be defined by either the presence or absence of the optically variable effect generating structure and may include multiple regions of the structure with multiple regions of absence. Alternatively, the image may be produced by spatially modulating the characteristics of the optically variable effect generating structure to define the image or sub-regions of the image. Such modulation may include a variation in a structural characteristic of the optically variable effect generating structure, for example its thickness or the pitch.

Preferably the image is recognisable and confers a meaning. The second image may be linked to a security document to which the element is applied, and may be configured to confer information about said document for authentication purposes. For example, the second image may confer information such as name, nationality, date of birth, denomination, currency, issue, bank and/or country information, depending on the document. In other examples the second image comprises a complex graphical image, such as a portrait or coat of arms.

As mentioned above, in some embodiments, the security element further comprises one or more substantially transparent optical spacer layers, each having respective opposing first and second surfaces, disposed between the first layer and the array of image elements, and/or between the first layer and the optically variable effect generating structure. The optical spacer layers may, for example, serve to space the image elements from the focussing elements such that the image elements are approximately in the focal plane of the focussing elements. The optical spacer layers may also, for example, provide coloured tints or a fluorescent effect to the appearance of the element to add further visual complexity.

The array of image elements may be disposed on, preferably in contact with, the second surface of the first layer, or on, preferably in contact with, the first or second surface of one of the one or more optical spacer layers, if provided.

As described above, the optically variable effect generating structure may be located between the first layer and the array of image elements. In such embodiments, the viewer will perceive the optically variable effect generating structure via the first layer. Typically, the optically variable effect generating structure will be close enough to the focussing elements such that distortion of the second image by the focussing elements is negligible.

Alternatively, the first layer may be located between the optically variable effect generating structure and the array of image elements. Such embodiments advantageously provide that the focussing elements are protected from damage, such as abrasion, in at least the second region by overlayers, which at least include the optically variable effect generating structure.

One type of optically variable effect generating structure which may be implemented in the security element according to the invention is a diffractive relief structure. Several classes of diffractive based security devices exist. Two common types, both based on arrays of surface diffraction gratings, are the “Exelgram” developed by CSIRO (Commonwealth Scientific and Industrial Research Organisation), Australia and the Kinegram, developed by Landis and Gyr, Switzerland. These are described in WO-A-93/18419, WO-A-95/04948 and WO-A-95/02200 for the Exelgram and U.S. Pat. No. 4,761,253 and EP-A-0105099 for the Kinegram. Both of these techniques use directly written localised surface diffraction gratings, written in the case of the Exelgram by an electron beam direct write process and in the case of a Kinegram by the recombining step and repeat process outlined in U.S. Pat. No. 4,761,253.

Surface diffraction grating devices are comprised of a complex 2D arrangement of pixels or structure elements, wherein each pixel or structure element contains an elementary grating structure. In one example each structure element could have the same grating structure and the resultant macro image would be defined by the location or absence of the structure elements. Alternatively the image could be defined by varying the grating structure across the device such that different regions of the image have a different grating structure. As is well known in the art the grating structure may be varied by varying the periodicity and/or the rotational orientation of the gratings in the surface plane or the azimuthal angles.

Another type of diffractive device that can exhibit optical switching effects is a holographic structure manufactured using conventional interferential holographic techniques. A typical example of such a device used as a security device on a bank note is the multiple redundant hologram described in EP-A-0558574 where to maintain holographic efficiency the hologram uses spatially separated switching images. In this process the images which will be in the form of graphical images recognisable by the naked eye are formed by the mechanism of diffraction of light where the original pattern has been generated by a holographic process of optical interference, whereby within the manufacturing stage of this origination process at least one component of the image may contain a rainbow hologram and where optionally at least one holographic intermediate hologram or H1 is used which enables at least one component of the resulting image optionally to contain true holographic depth effects if desired (as associated with 2D/3D or 2D rainbow holograms as known in the art). This description also applies to surface 2D structures generated by the above holographic process but constrained to lie substantially on the image plane of the final device and with the preferred option of being constrained in the range of spatial frequencies contained therein (i.e. viewing angle of replay). This forms in the limiting case of extreme constraint a holographic structure substantially similar in visual performance to a pure diffraction grating structure but subtly distinct in that on a microscopic level the microstructure will have been formed by a holographic projection process and may contain evidence of recorded laser generated speckle pattern structures.

In some embodiments, the optically variable effect generating structure comprises a diffractive relief structure formed in the second surface of the first layer in at least the second region. In these embodiments, the first layer provides both the array of focussing elements in its first surface and at least part of the optically variable effect generating structure in its second surface. Such embodiments can lead to a very compact, thin security element with improved visual complexity.

In some embodiments, the optically variable effect generating structure comprises: a second layer, the second layer having opposing first and second surfaces, and preferably being formed of a substantially transparent second material, Preferably, there is further provided a diffractive relief structure formed in the first surface of the second layer in at least the second region. In some such embodiments, the second surface of the second layer is in contact with the first surface of the first layer, the second surface of the second layer conforming to the array of focussing elements formed in the first surface of the first layer, and preferably the second material having a second refractive index, different from the first refractive index. In these embodiments, the second layer, as well as providing the diffractive relief structure for generating the second image, also acts as an overcoat of the focussing elements in the first layer, thereby protecting the focussing elements, at least in the second region, from damage, such as by abrasion. So that the protective overcoat provided by the second layer protects all focussing elements, preferably the second layer is present over the entire first region. In such embodiments, the diffractive relief structure may be present in the surface of the second layer over the entire first region, or may be confined to a region of the surface only partially overlapping the first region.

In all embodiments which feature a diffractive relief structure, it is preferable that the diffractive relief structure is at least partially coated in a reflection enhancing material. Such a reflection enhancing coating makes it possible to increase the brightness of the effect produced by the diffractive relief structure, thereby improving the appearance of the finished element. Preferably the reflection enhancing layer is a substantially transparent high refractive index material, such as a metal oxide, and further, preferably the reflection enhancing material has a refractive index greater than 1.5, preferably greater than 1.75, more preferably greater than 2.0. The reflection enhancing material may be applied as a continuous coating covering all or a part of the diffractive relief structure. Alternatively, the reflection enhancing layer could be applied in accordance with a screen pattern, for example a pattern of dots. In some embodiments, the reflection enhancing layer is applied with a fill factor lower than 20% and/or with a dot size smaller than 150 μm. While a reflection enhancing layer is preferable, in some embodiments a reflection enhancing layer is not necessary, and instead it is possible to rely on refractive index difference of, for example, 0.2-0.3 across the boundary of the diffractive relief structure. For example, this may be the case in embodiments which feature a non-diffuse diffractive structure, preferably generated by direct write methods such as e-beam. Non-diffuse diffractive structures are described in detail in WO 2008152389 A1 and exhibit a specular diffractive replay. When collimated light of a particular wavelength is incident on a non-diffuse diffractive structure, then each structure element within the active image area will diffract or re-direct this light in a specific direction as determined by its singular grating function and the diffraction equation. In other words, light from a single incoming direction (a ray) is redirected by the grating structure element into a single outgoing direction according to the geometrical laws of diffraction. As the incoming light is not diffused the intensity of the diffracted light is strong and therefore it is possible to observe the effect without a reflection enhancing coating.

In all embodiments which feature a diffractive relief structure in the first surface of a second layer, it is preferable that the second surface of the first layer is located directly on either the first surface of the second layer or, if provided, the reflection enhancing material coating the first surface of the second layer, the second surface of the first layer preferably conforming to the diffractive relief structure formed in the first surface of the second layer in the second region. Providing the first layer directly on the diffraction relief structure or reflection enhancing material coating the diffraction relief structure enables the security element to be thin and compact whilst still providing the desired increase in visual complexity. In such embodiments, when the second surface of the first layer conforms to the diffractive relief structure formed in the first surface of the second layer, the conjugate of the diffractive relief structure is formed in the second surface of the first layer. When the second surface of the first layer is located directly on the first surface of the second layer, the second layer should be formed of a material having a second refractive index, so that a refractive index difference exists across the boundary at the diffractive relief structure. However, where the second surface of the first layer is located directly on the reflection enhancing material coating the first surface of the second layer, a refractive index difference should be provided between the reflection enhancing material and either or, more typically, both of the first and second layer.

In some embodiments, the diffractive relief structure is partially coated in a substantially opaque reflection enhancing material, such as a metal layer, the second region being the region of the diffractive relief structure coated in the substantially opaque reflection enhancing material. In these embodiments, the diffractive relief structure may extend beyond the boundaries of the second region. The diffractive relief structure is coated in an opaque reflection enhancing material, with the opaque reflection enhancing layer defining the perimeter of the second region. Those areas of the diffractive relief structure not coated in a substantially opaque reflection enhancing material, if present, may add yet further visual complexity to the device, by providing a region of reduced replay brightness in which the first image is visible in superposition in addition to the region in which only the second image is visible (i.e. the region of the overlap of the first and second regions). Alternatively, the second image may be exclusively visible in the second region, and the first image exclusively visible in the first region where it is not overlapped by the second region.

In some embodiments, the optically variable effect generating structure comprises a reflective and/or refractive relief structure. Such a structure may be, for example, an array of facets which could be different types of prisms or pyramidal structures. Reflective/refractive elements such as facets can be configured to display different intensities (i.e. brightnesses) at different viewing angles, and can therefore be used to generate the second image.

In some embodiments, the second region comprises a plurality of discrete sub-regions. Further, preferably the periphery of the second region, or the peripheries of the sub-regions of the second region if provided, defines the second image. For example, the optically variable effect generating structure may be provided in a second region which is shaped as a numeral or currency symbol. As an example, the result may appear to a viewer to be a currency symbol or currency symbols which changes colour, but not position, upon tilting, while the array of focussing elements in combination with the image elements displays, as a result of the moiré effect for example, a number, or numbers, representing a denomination, which do move upon tilting, with the two images appearing superimposed on one another.

In those embodiments in which the second region comprises discrete sub-regions, optionally the optically variable effect generating structure has first structural characteristics in a first set of the sub-regions and second structural characteristics in a second set of the sub-regions. For example, where the optically variable effect generating structure is a diffraction grating, the grating may have a first pitch and/or thickness in a first set of sub-regions and a second pitch and/or thickness in a second set of sub-regions.

Preferably, the array of focussing elements is an array of lenses, preferably an array of microlenses, formed by a lens relief in the first surface of the first layer. The microlenses may, for example, each have a base diameter of less than 250 μm, and preferably in the range 5-80 μm and more preferably in the range 5-50 μm and even more preferably 5-30 microns. Further, the array of lenses may be either a one-dimensional array of cylindrical lenses, or a two-dimensional array of spherical or aspherical lenses. The lenses may be either concave or convex. While lenses are preferable, other focussing elements could also be used, such as mirrors.

As mentioned above, two major categories of focussing element based security elements are lenticular devices and moiré magnification devices, both of which may be implemented in the security element according to the present invention.

Therefore, in some embodiments the array of image elements comprises at least a first set of image element portions, each image element portion comprising a portion of the first image and being associated with a respective one or more focussing elements of the array of elements. Alternatively, the array of image elements may comprise an array of microimage elements, the array of microimage elements having a pitch and/or orientation different from the pitch and/or orientation of the array of focussing elements such that the first image is a magnified version of the microimage elements, generated as a result of the moiré effect.

In some embodiments, the array of image elements is an array of printed image elements. The elements may be printed using gravure printing, lithographic printing, flexographic printing, offset printing or screen printing processes.

In particularly preferable embodiments, the array of image elements comprises an array of image elements defined by one or more diffraction relief structures. For example, the image elements may be defined by diffractions gratings or other such first order or zero order diffractive structures. In other cases, the array of image elements comprises an array of image elements defined by one or more arrays of nanostructures. For example, arrays of nanostructures include moth-eye nanostructures and other such nanostructured arrays. Examples of image elements formed by moth-eye structures may be found in WO 2005106601 A2, while examples of nanostructured arrays may be found in WO 2014179892 A1.

In other embodiments, the array of image elements comprises an array of image elements defined by a discontinuous metal layer.

Yet further image element defining structures may include stepped surface relief optical structures known as Aztec structures (see for example WO 2005/115119 A2) or simple scattering structures.

Printed image elements are typically limited by conventional printing processes to a minimum line width of approximately 10 micrometres. Particularly where the focussing elements are lenses, this restricts the smallest possible focussing element size, i.e. lens base diameter, to on the order of 10 micrometres. With this minimum lens base diameter, providing a structure which is not overly thick, i.e. which has a sufficiently short focal length of the focussing elements, requires the generation of a large refractive index difference at the boundary defining the lens relief. Where the first layer is overcoated by a second, conformal layer, this requires the refractive indices to be selected so as to generate a large refractive index difference at the boundary between the two layers. However, embodiments which comprise image elements defined by diffraction structures, nanostructures or a discontinuous metal layer are particularly preferable since image elements defined by these means allow very small image elements to be produced. This, in turn, allows smaller diameter lenses to be used, which can have the short focal lengths required for a thin overall structure without a large refractive index difference being required.

According to a second aspect of the invention, there is provided a security document having a security element according to the first aspect. Preferably, said security document is a banknote, an identity document, a passport, a licence, a certificate, a cheque, a visa or a stamp.

According to a third aspect of the invention, there is provided a method of forming a security element comprising: providing a first layer of a substantially transparent first material having a first refractive index, the first layer having opposing first and second surfaces; forming in a first region of the first surface of the first layer an array of focussing elements; providing an optically variable effect generating structure over the first layer in a second region at least partially overlapping the array of focussing elements in the first region; and providing an array of image elements over the array of focussing elements such that a first image, formed from at least some of the image elements, is displayed to a viewer viewing the image elements via the array of focussing elements of the first layer; wherein the optically variable effect generating structure is configured to display, in the second region, a second image to the viewer.

This aspect of the invention corresponds to the manufacture of a security element in accordance with the first aspect. All of those comments on the interpretation of words apply equally to this aspect of the invention. Further, the advantages associated with each feature of the first aspect exist for the corresponding feature of the third aspect. Additional advantages inherent to the method will be discussed below.

As with the first aspect, in some embodiments, the method further comprises providing one or more substantially transparent optical spacer layers between the first layer and the array of image elements, and/or between the first layer and the optically variable effect generating structure, each optical spacer layer having respective opposing first and second surfaces. Further, in some embodiments providing the array of image elements over the array of focussing elements comprises providing the array of image elements on the second surface of the first layer, or on the first or second surface of one of the one or more optical spacer layers, if provided.

In some embodiments the optically variable effect generating structure is provided between the first layer and the array of image elements. Alternatively, in some embodiments, the first layer is provided between the optically variable effect generating structure and the array of image elements.

Preferably, the first material is a first curable material, and forming the array of focussing elements comprises casting an array of focussing elements in the first surface of the first layer and curing the first curable material. A curable material is one which hardens (i.e. becomes more viscous and preferably solid) in response to exposure to curing energy which may for example comprise heat, radiation (e.g. UV) or an electron beam. The hardening involves a chemical reaction such as cross-linking rather than mere physical solidification, e.g. as is experienced by most materials upon cooling. The low viscosity of the pre-curing state facilitates application of the material, especially where the material is to conform to the shape of a material to which it is applied. While cast-curing processes are preferable, alternative means of forming relief structures, such as the array of focussing elements, may be used, e.g. embossing.

In some embodiments, providing the optically variable effect generating structure comprises forming a diffractive relief structure in the second surface of the first layer in at least the second region. In some such embodiments, the first material is a first curable material, and forming a diffractive relief structure in the second surface of the first layer comprises casting the diffractive relief structure in the second surface of the first layer and curing the first curable material. While preferable, alternative means of forming the diffractive relief structure in the second surface of the first layer may be used, such as embossing.

In particularly preferable embodiments, providing the optically variable effect generating structure comprises: providing a second layer (preferably of a substantially transparent second material), the second layer having opposing first and second surfaces; and forming a diffractive relief structure in the first surface of the second layer in at least the second region. In such embodiments, preferably the second material is a second curable material, and forming the diffractive relief structure comprises casting the diffractive relief structure in the first surface of the second layer and curing the second curable material.

In some embodiments providing the second layer comprises providing the second surface of the second layer in contact with the first surface of the first layer such that the second surface of the second layer conforms to the array of focussing elements formed in the first surface of the first layer, wherein the second material has a second refractive index, different from the first refractive index. In these embodiments, the first layer may be provided, and the lenses cast cure into the first surface. Subsequently, the first layer may be overcoated with the second layer, which protects the first layer and provides the second visual effect. Preferably, the second material is a second curable material, and the method further comprises curing the second curable material after providing the second surface of the second layer in contact with the first surface of the first layer such that the second surface of the second layer conforms to the array of focussing elements formed in the first surface of the first layer comprises. In other words, the second layer is provided over the first layer in an uncured state such that it conforms to the shape of the focussing elements, and the second layer is then cured. The curing may, for example, also fix a diffractive relief structure formed in the first surface of the second layer, thereby providing a particularly advantageous way of overcoating the focussing element array with an optically variable layer.

In some embodiments, providing the second layer comprises providing the second layer over the entire first region. All of the focussing elements may thereby be protected by the provision of the second layer.

Some embodiments further comprise coating the diffractive relief structure at least partially in a reflection enhancing material. Preferably, the reflection enhancing material is a substantially transparent high refractive index material, such as a metal oxide. Further preferably, the reflection enhancing layer has a refractive index greater than 1.5, preferably greater than 1.75, more preferably greater than 2.0. In all such embodiments, preferably the reflection enhancing material is applied using a vacuum deposition process.

In particularly preferable embodiments, the optically variable effect generating structure comprises a hologram.

In some embodiments, the second surface of the first layer is provided directly on the first surface of the second layer or, if there is provided a reflection enhancing material, directly on the reflection enhancing material coating the first surface of the second layer. In some such embodiments the first material is a first curable material, and the method further comprises curing said first curable material after the first layer is provided directly on the first surface of the second layer or directly on the reflection enhancing material coating the first surface of the second layer. In these embodiments, the first layer may be provided over the second layer, which, for example, may have had the optically variable effect generating structure cast cured into its surface and optionally coated with a reflection enhancing material, before curing. The first layer may conform to diffractive relief structure, and the focussing elements formed in its upper surface. Curing the first layer would then fix both the second surface, conforming to the diffractive relief structure, and the first surface, having an array of focussing elements formed therein, in their desired shape.

Curing of materials forming the security element may be performed in one or more curing steps. The material may be partly cured before any casting is performed to increase its viscosity and help the material retain a cast (or embossed) surface relief, cured further after casting is performed to fix the cast surface relief in the material, and cured further still after one or more additional layers have been applied over said material to improve the bonding between those layers.

In particularly preferable embodiments, the diffractive relief structure is partially coated in a substantially opaque reflection enhancing material, such as a metal layer, the second region being the region of the diffractive relief structure coated in the substantially opaque reflection enhancing material. This may be done by depositing, for example by vacuum deposition, an opaque reflection enhancing material across the surface of the second layer, applying a clear lacquer layer over the reflection enhancing material, and demetallising the unprotected areas to leave a partially coated diffractive relief structure. Alternatively, a metallic ink, preferably a platelet ink, could be directly printed onto the diffractive relief structure in the second region, preferably in register with the diffractive regions.

In some embodiments, providing the optically variable effect generating structure comprises providing a reflective and/or refractive relief structure. The provision of such structures is known, for example, from EP-A-1047960 and U.S. Pat. No. 5,591,527.

Preferably, providing the optically variable effect generating structure in the second region comprises providing the optically variable effect generating structure in a plurality of discrete sub-regions. Further, preferably the periphery of the second region, or the peripheries of the sub-regions of the second region if provided, defines the second image.

In particularly preferable embodiments, the array of focussing elements is an array of lenses, preferably an array of microlenses, and forming the array of lenses comprises forming a lens relief in the first surface of the first layer. The array of lenses may be either a one-dimensional array of cylindrical lenses, or a two-dimensional array of spherical or aspherical lenses.

In some embodiments, forming the array of image elements comprises forming at least a first set of image element portions, each image element portion comprising a portion of the first image and being associated with a respective one or more focussing elements of the array of elements. Alternatively, forming the array of image elements may comprise forming an array of microimage elements, the array of microimage elements having a pitch and/or orientation different from the pitch and/or orientation of the array of focussing elements such that the first image is a magnified version of the microimage elements, generated as a result of the moiré effect. In any case, preferably forming the array of image elements comprises printing the array of image elements.

In particularly preferable embodiments, forming an array of image elements comprises forming an array of image elements defined by one or more diffraction relief structures or one or more arrays of nanostructures, as described above.

Forming the array of image elements as either a diffraction relief structure or an array of nanostructures may comprise embossing or cast curing the array of image elements into the surface of an image element receiving layer. In some cases, forming the array of image elements comprises forming the array of image elements in an image element layer separate from the security element and applying the image element layer such that it overlaps the focussing elements of the security element. In other cases, the array of image elements may be formed in the second surface of the first layer or in the first or second surface of one of the one or more optical spacer layers, if provided.

In other embodiments, forming an array of image elements comprises forming an array of image elements defined by a discontinuous metal layer. Such image elements may be produced by patterning of a metal layer through the use of a photosensitive resist material and exposure the resist to appropriate radiation through a mask. Depending on the nature of the resist material, exposure to the radiation either increases or decreases its solubility in certain etchants, such that the pattern on the mask is transferred to the metal layer when the resist-covered metal substrate is subsequently exposed to the etchant. For instance, EP 0987599 A2 discloses a negative resist system in which the exposed photoresist becomes insoluble in the etchant upon exposure to ultraviolet light. The portions of the metal layer underlying the exposed parts of the resist are thus protected from the etchant and the final pattern formed in the metal layer is the “negative” of that carried on the mask. In contrast, WO 2016/198876 A1 discloses a positive resist system in which the exposed photoresist becomes more soluble in the etchant upon exposure to ultraviolet light. The portions of the metal layer underlying the unexposed parts of the resist are thus protected from the etchant and the final pattern formed in the metal layer is the same as that carried on the mask. Again, the image elements defined by the discontinuous metal layer may be formed on an image element layer separate from the security element, which is then applied such that it overlaps the focussing elements. Alternatively, the discontinuous metal layer may be provided on the second surface of the first layer of material or on the first or second surface of one of the one or more optical spacer layers, if provided.

As mentioned above, these methods of forming image elements can produce relatively small image elements, which allows smaller diameter focussing elements to be used, which in turn lessens restrictions on the refractive indices of the layers.

The present invention will now be described with reference to the accompanying drawings, in which:

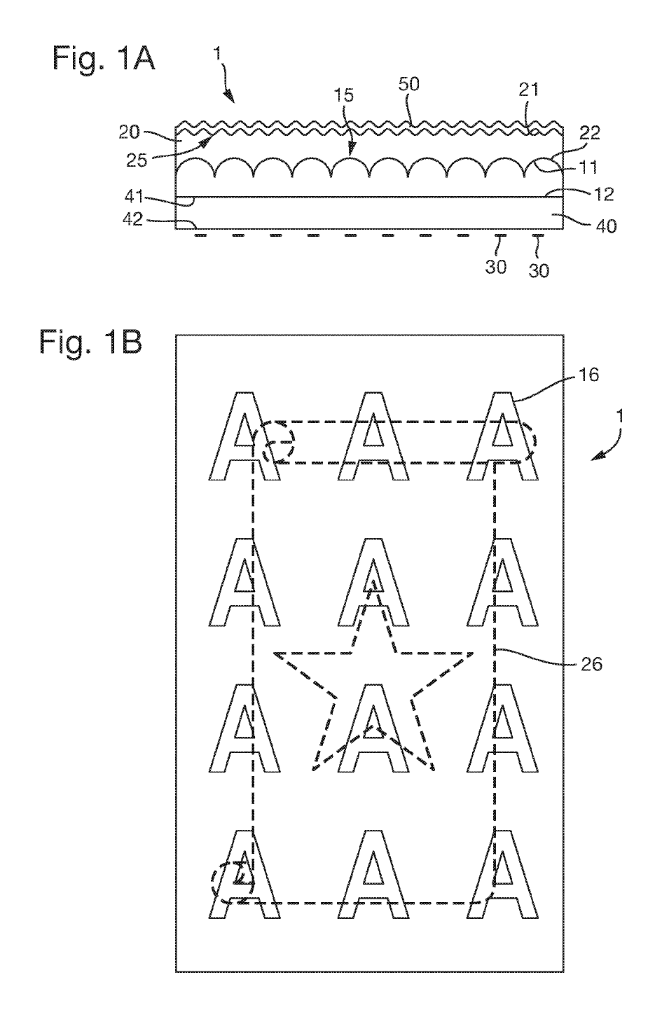

FIG. 1A shows, schematically, the cross-section of a security element according to a first embodiment, and FIG. 1B shows, schematically, the appearance of the security element of the first embodiment;

FIG. 2 shows, schematically, the cross-section of a security element according to a second embodiment;

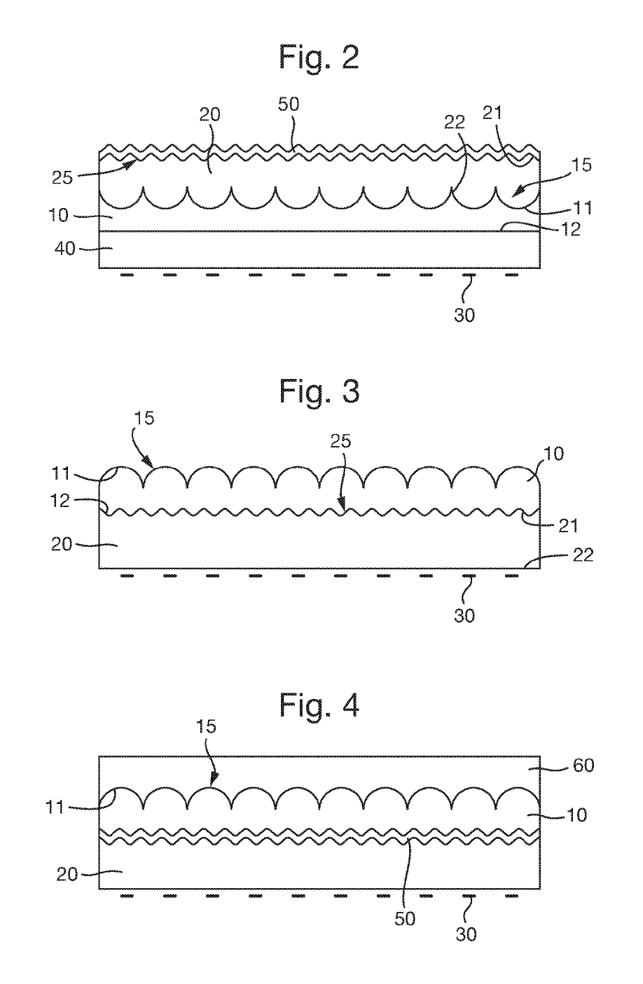

FIG. 3 shows, schematically, the cross-section of a security element according to a third embodiment;

FIG. 4 shows, schematically, the cross-section of a security element according to a fourth embodiment;

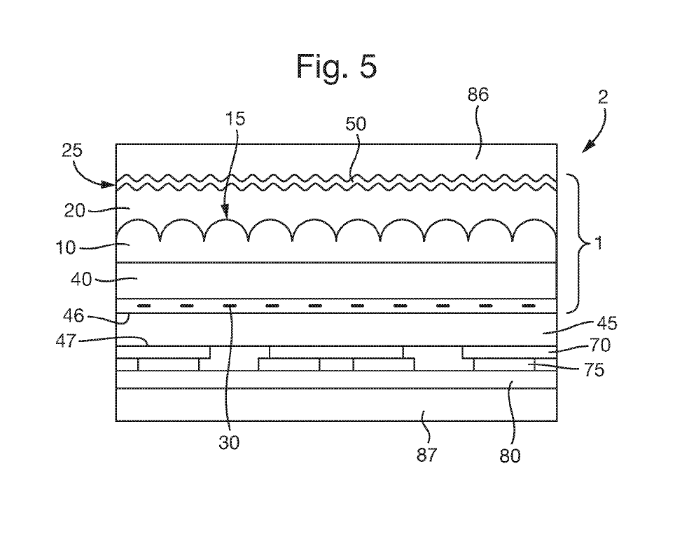

FIG. 5 shows, schematically, the cross-section of a security thread in accordance with the first embodiment;

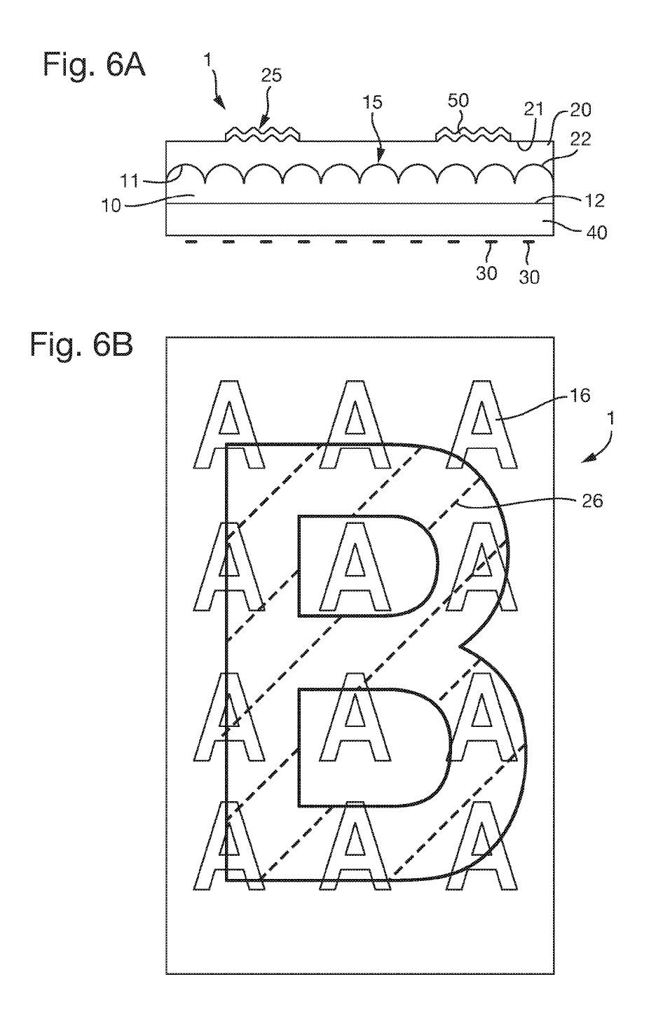

FIG. 6A shows, schematically, the cross-section of a security element according to a fifth embodiment, and FIG. 6B shows, schematically, the appearance of the security element of the fifth embodiment;

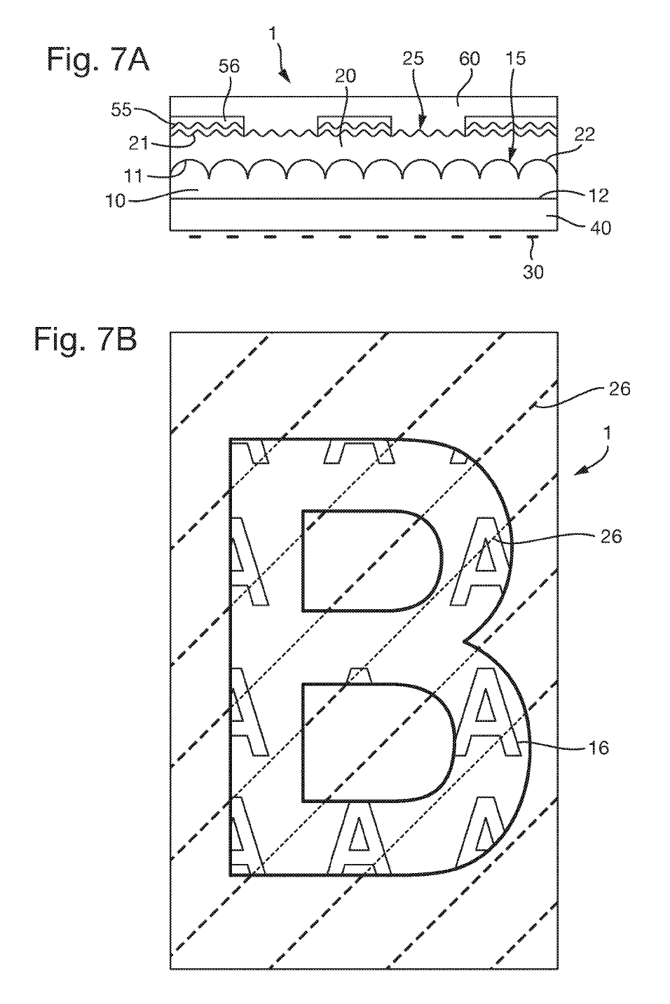

FIG. 7A shows, schematically, the cross-section of a security element according to a sixth embodiment, and FIG. 7B shows, schematically, the appearance of the security element of the sixth embodiment;

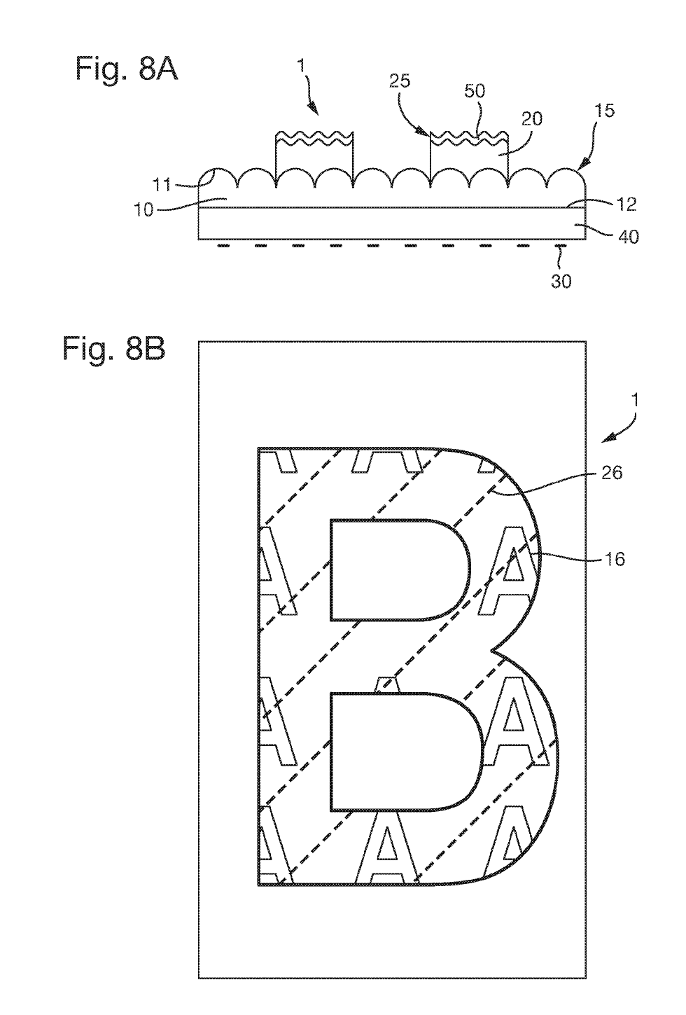

FIG. 8A shows, schematically, the cross-section of a security element according to a seventh embodiment, and FIG. 8B shows, schematically, the appearance of the security element of the seventh embodiment;

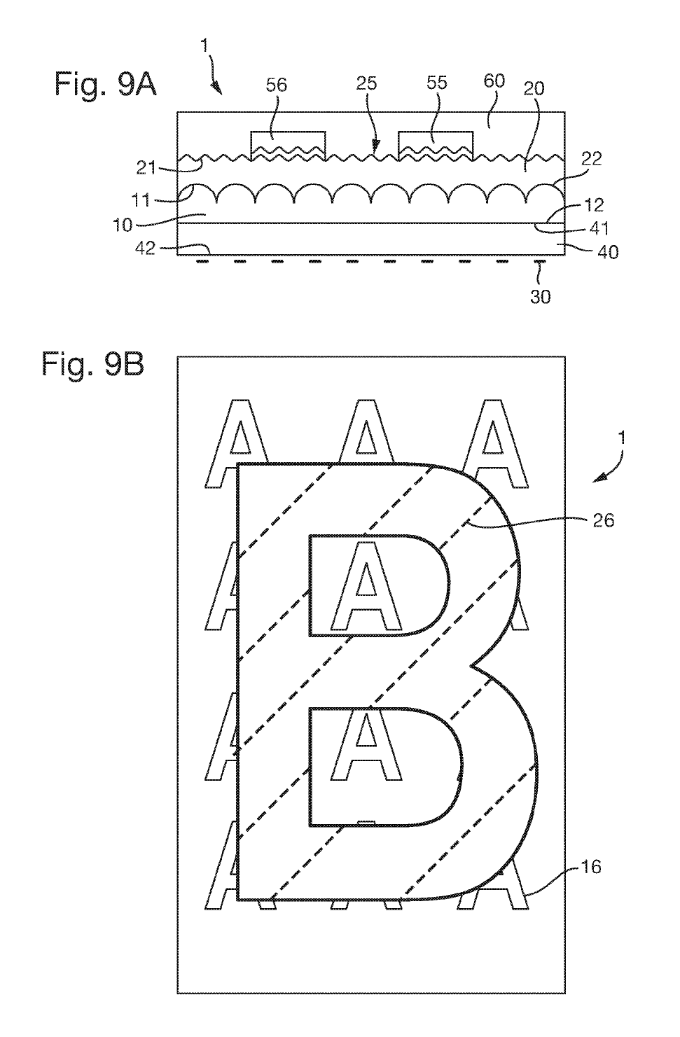

FIG. 9A shows, schematically, the cross-section of a security element according to an eight embodiment, and FIG. 9B shows, schematically, the appearance of the security element of the eight embodiment;

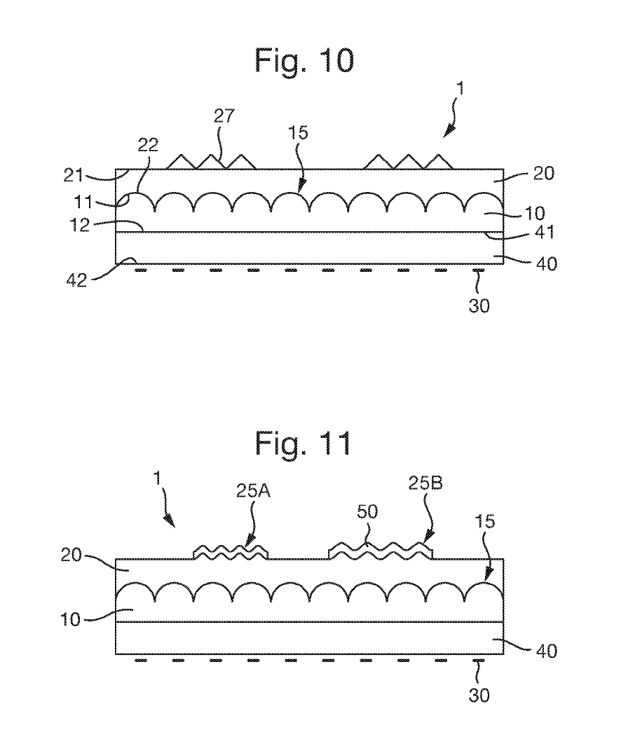

FIG. 10 shows, schematically, the cross-section of a security element according to a ninth embodiment;

FIG. 11 shows, schematically, the cross-section of a security element according to a tenth embodiment;

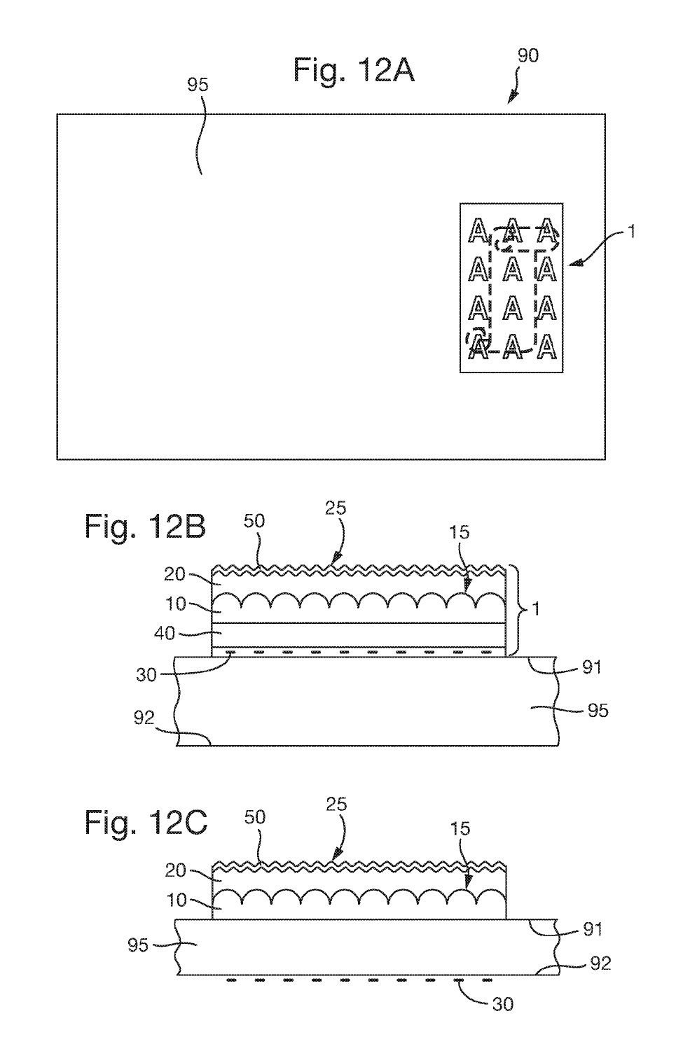

FIG. 12A shows a schematic plan view of a security document incorporating the security element according to the first embodiment, FIGS. 12B and 12C show, schematically, the cross-section of the security document and security element according to first and second variants;

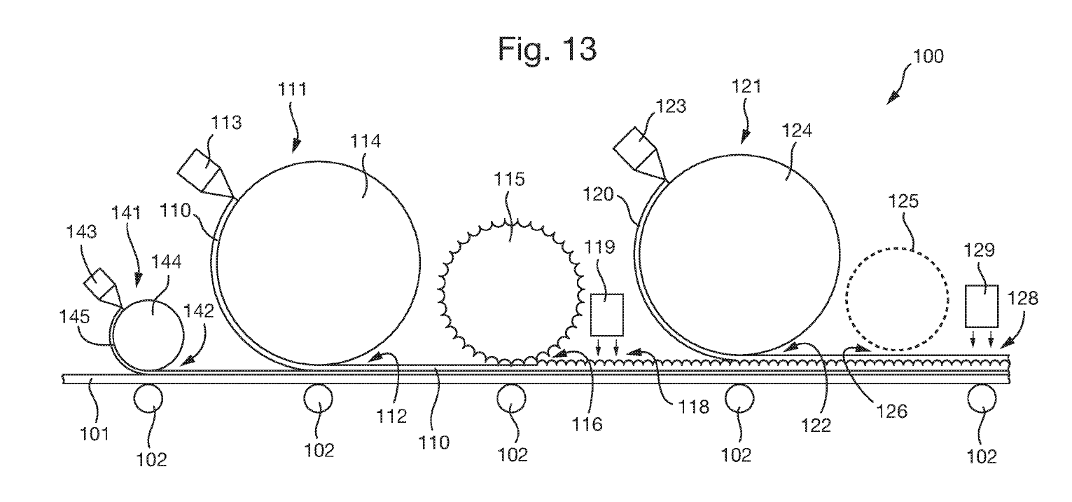

FIG. 13 shows, schematically, a system suitable for implementing a method according to a first embodiment;

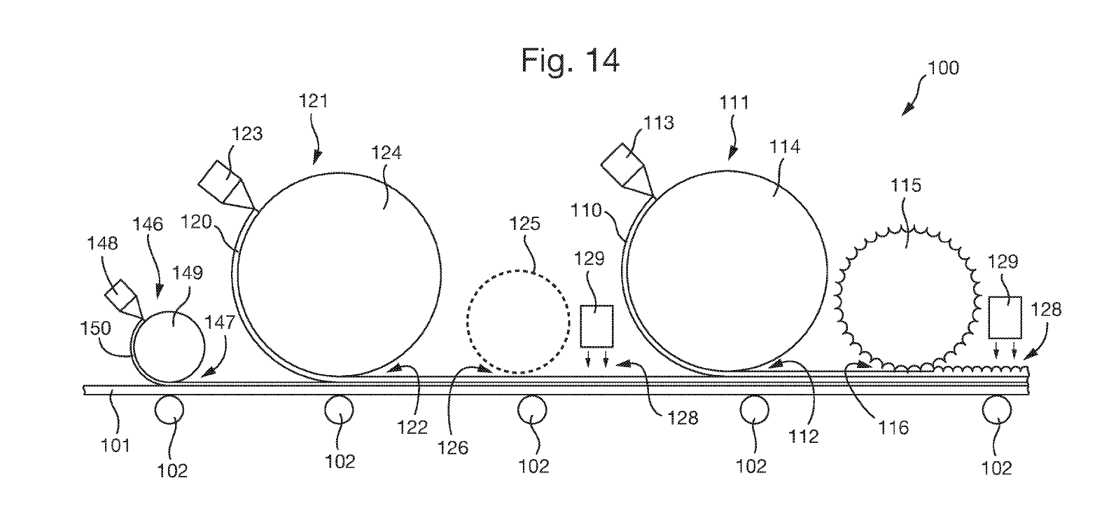

FIG. 14 shows, schematically, a system suitable for implementing a method according to a second embodiment;

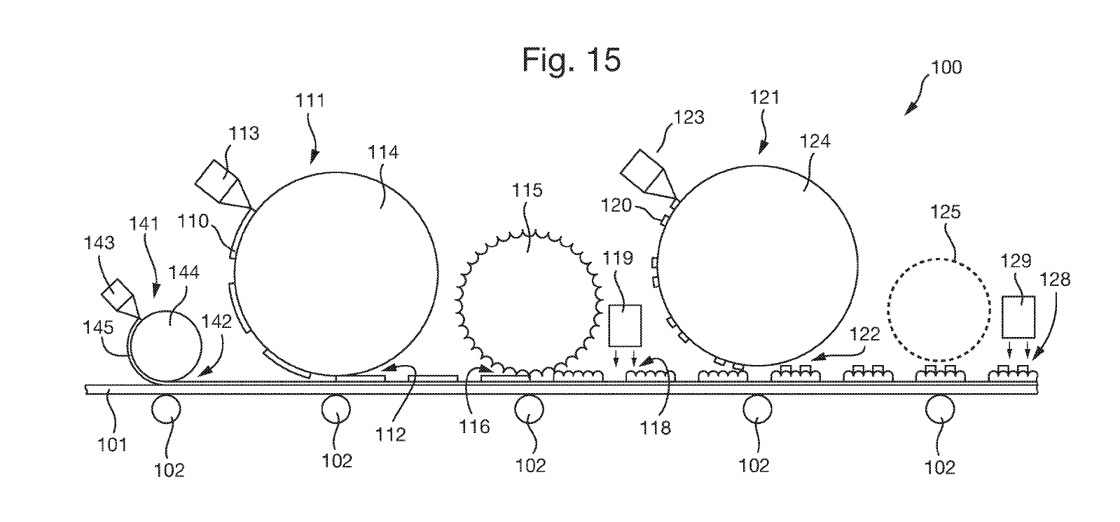

FIG. 15 shows, schematically, a system suitable for implementing a method according to a third embodiment;

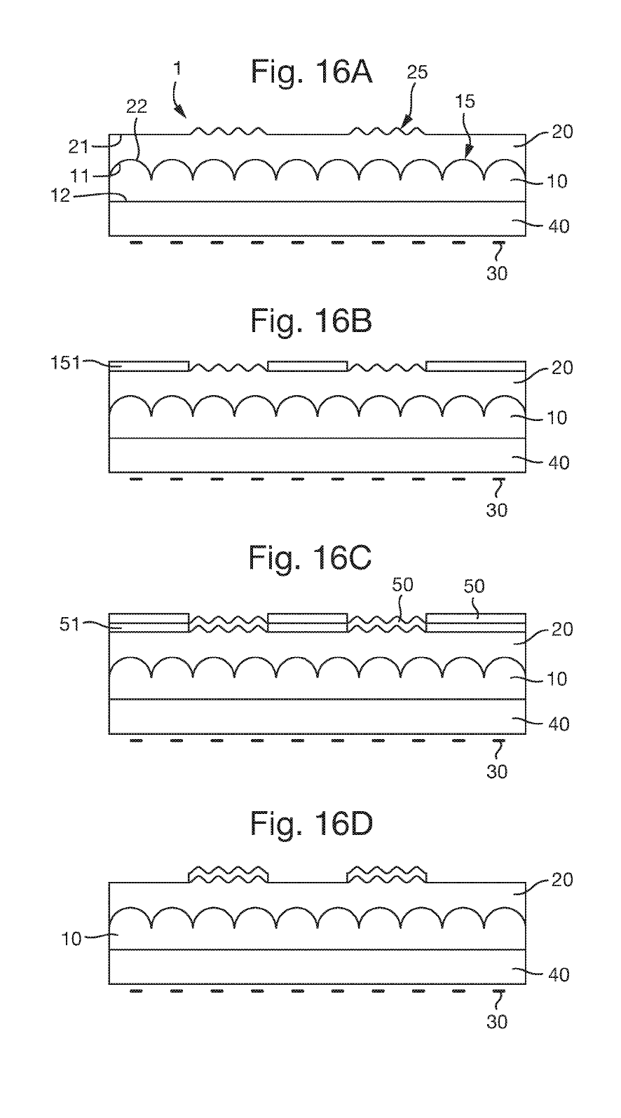

FIG. 16A to 16D show schematic cross-sections of the security element of the fifth embodiment at four different stages of manufacture;

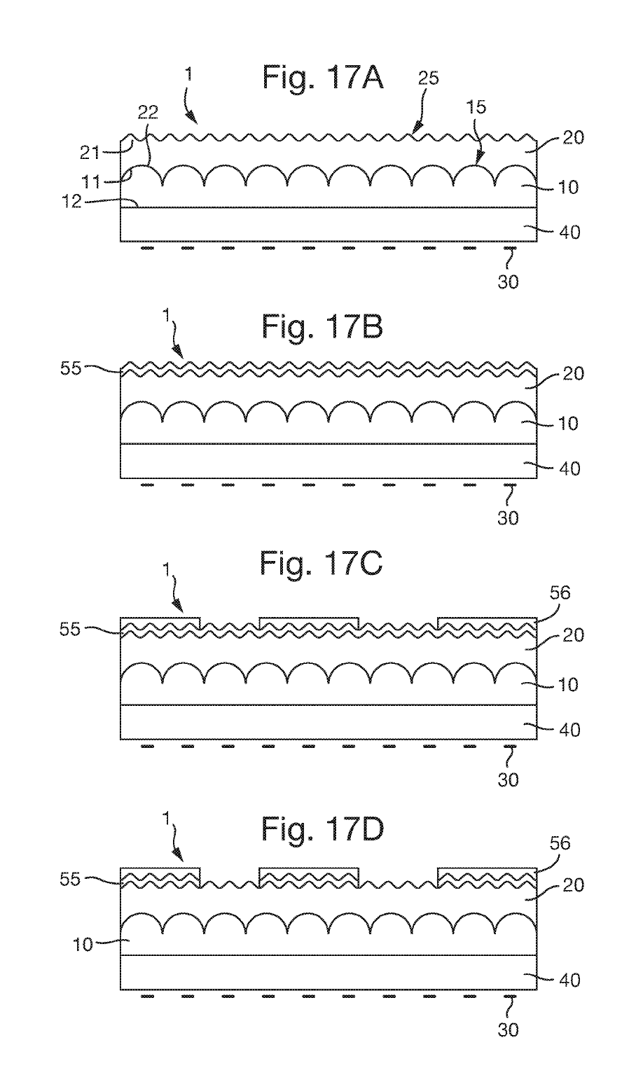

FIG. 17A to 17D show schematic cross-sections of the security element of the sixth embodiment at four different stages of manufacture; and

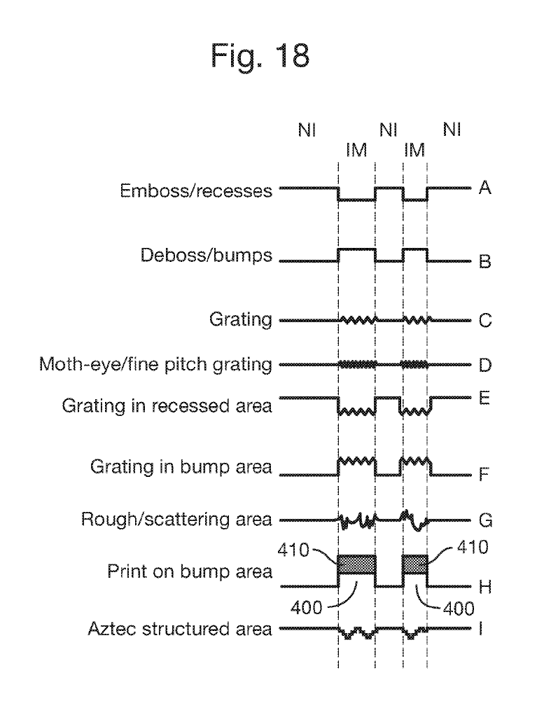

FIGS. 18A to 18I illustrate different examples of relief structures which may be used to define image elements in accordance with the present invention.

A first embodiment of a security element according to the present invention will now be described in detail with reference to FIG. 1. The structure of the security element is shown in a schematic cross-section in FIG. 1A. The security element 1 according to the first embodiment of the present invention comprises a first layer 10 of transparent material (suitable material compositions for this and other layers will be discussed below). The first layer is formed of a first, curable resin, and has opposing surfaces 11, 12. The first (upper in the Figure) surface 11 of the first layer 10 features an array of lenses 15 defined by a lens relief structure in the first surface, which is formed by a cast cure process (the method by which the first layer is formed will be discussed in greater detail below). The lens array 15 is present in the surface of the first layer in a first region, which in this case is the entire area of the security element. In this embodiment, the lenses are a two dimensional array of spherical, convex lenses, and the optical effect they generate is based on the moiré effect. However, it will be appreciated that different types of lenses, e.g. cylindrical or aspherical lenses, can be used with a suitable corresponding array of image elements to generate any of the optically variable effects known in the art and discussed above (for example, lenticular effects or integral imaging effects). The second surface 12, opposite the first surface 11, is substantially planar.

A second layer 20 is located over the first layer 10, and directly in contact with the first surface 11 of the first layer 10. The second surface 22 of the second layer, i.e. the surface directly in contact with the first surface 11 of the first layer 10, conforms to the lens relief structure in the first surface 11 of the first layer 10, exhibiting the conjugate of the lens relief structure. The second layer 20 is formed of a second, curable resin, and has a refractive index that is lower than the refractive index of the first, curable resin. The refractive index difference between the two layers is selected in combination with the lens dimensions, such that lenses have the desired focal length, and one skilled in the art will be capable of configuring the refractive index difference and lens dimensions for any particular security element in view of the present teachings.

The first surface 21 of the second layer 20, opposite the second surface 22, has formed therein a diffractive relief structure 25. The diffractive relief structure is formed by a cast cure process, as will be described in greater detail below. The diffractive relief structure may be, for example, a hologram, Kinegram, or diffraction grating. The diffractive relief structure is present in the first surface 21 of the second layer 20 in a second region, which in this case is the entire area of the security element. The first surface 21 of the second layer 20 is coated in a substantially transparent high refractive index (HRI) material 50 whose upper and lower surfaces substantially match the diffractive relief structure in the first surface of the second layer. The high refractive index provides a large refractive index difference at the boundary of the first surface 21 of the second layer 20 to increase the replay brightness of the optically variable effect generated by the diffraction relief structure. Suitable HRI layers are well known in the art, and include, for example, zinc sulphide (ZnS), zirconium dioxide (ZrO₂) or metal oxides such as zinc oxide (ZnO), titanium dioxide (TiO₂), aluminium oxide (Al₂O₃) etc.

It should be noted that the transparent high refractive index material 50 is optional in this embodiment and all other embodiments in which it is shown. In alternative embodiments, the material (or materials) is selected such that a refractive index difference of, for example, 0.2-0.3 exists across the boundary of the diffractive relief structure.

The security element further includes an optical spacer layer 40, which is located on the second surface 12 of the first layer 10, i.e. opposite the surface having the lens relief structure 15. The optical spacer layer 40 may have a first surface 41 directly in contact with the second surface 12 of the first layer 10, or they may be separated by a primer or adhesive layer or the like. The optical spacer layer may be another curable resin, or may be provided as a visually transparent polymer such as polypropylene. In this embodiment, the second surface 42 of the optical spacer layer 40 lies approximately in the focal plane of the array of lenses 15.

On the second surface 42 of the optical spacer layer 40 is arranged an array of image elements 30. In this embodiment the image elements are microimage elements, with each microimage element being a printed ‘A’. As is understood in the art, microimage elements may be printed, for example, using any of gravure printing, lithographic printing, flexographic printing, offset printing or screen printing processes. In alternative embodiments, each microimage element may be defined by one or more diffraction relief structures, such as a diffraction grating, or by one or more arrays of nanostructures. Alternatively, a discontinuous metal layer may be used to either positively or negatively define the image elements. As described above, the present embodiment utilises the moiré effect to generate an optically variable image, and hence a pitch mismatch exists between the array of image elements 30 and the array of lenses 15.

The appearance of the security element will now be described with respect FIG. 1B. The viewer views the security element 1 by arranging it so that the diffractive relief structure 25 and the array of lenses 15 are positioned between the viewer and the array of image elements 30. Under these viewing conditions, two optically variable effects are visible to the viewer. Firstly, a diffractive optical effect 26 (shown as a scroll featuring a star) is visible in the second region, i.e. the region over which the diffractive relief structure is present. As will be appreciated, the diffractive relief structure 25 can be configured to exhibit many different types of image or pattern by configuring the precise shape and spatial modulation of the diffractive relief structure 25. The diffractive optical effect 26 will exhibit a change as the device is tilted in accordance with the precise design of the diffractive relief structure 25, and will act as a first optically variable effect.

As a result of the transparency of the second layer 20 and HRI coating 50 across the second region (which is, in this case, coincident with the entire first region), the optically variable effect produced by the lenses 15 in combination with the image elements 30 is visible superimposed with the diffractive optical effect 26 described above. In this embodiment, a moiré magnification effect 16 is visible across the first region. The lenses 15 in combination with the image elements 30 present a synthetically magnified version of the array of image elements 30 to the viewer, as is known in the art. The synthetically magnified version of the array of image elements 30 appears in an image plane, which may lie above or below the security element, and which will appear to move across the device upon tilting of the device.

As mentioned above, the two images 16, 26 produced by the security element appear superimposed on one another by virtue of the transparency of the first and second layers 10, 20 in the region in which the diffractive relief structure 25 and the lens 15 and microimage arrays 30 overlap. Not only does this provide the security element with a complex appearance at first viewing angle, but the different mechanisms by which the images are produced mean that the images vary upon tilting in different ways, resulting in a visually striking appearance upon investigation of the security element by tilting.

A second embodiment will now be described with reference to FIG. 2. The second embodiment is substantially the same as the first embodiment, and the differences between the two will be focussed on in the following description.

In the second embodiment, the first layer 10 has formed in its first surface 11 a two dimensional array of spherical, concave lenses, 15. The array of concave lenses 15 are again defined by a lens relief structure in the first surface 11 formed by a cast cure process to be described in more detail below, and the second surface 22 of the overlying second layer 20 conforms to this concave lens relief structure.

The first layer 10 is formed of a material having a lower refractive index than the material of the second layer 20, with a refractive index difference again being selected so that the lenses have the desired focal length.

The security element of the second embodiment has the same, microimage elements 30, optical spacer layer 40 and HRI layer 50 as the first embodiment. The appearance of the device may, therefore, be substantially identical to the appearance of the embodiment.

A third embodiment will now be described with reference to FIG. 3. The third embodiment of a security element 1 comprises a first layer 10 of transparent material. The first layer is formed of a first, curable resin, and has opposing surfaces 11, 12. The first (upper in the Figure) surface 11 of the first layer 10 features an array of lenses 15 defined by a lens relief structure in the first surface, which is formed by a cast cure process. The lens array 15 is present in the surface of the first layer in a first region, which in this case is the entire area of the security element. In this embodiment, the lenses are a two dimensional array of spherical, convex lenses. The first layer 10 is the uppermost layer of the security element 1, and hence the lenses 15 have dimensions and the first material has a refractive index that are selected so that the lenses have the desired focal length when the lens boundary is with air.

A transparent second layer 20 formed of a second, curable material is located directly on the second surface 12 of the first layer 10. The boundary between the first layer and the second layer, i.e. the second surface 12 of the first layer 10 and the first surface 21 of the second layer 20, defines a diffractive relief structure 25. As will be described in more detail below, the diffractive relief structure 25 may have been formed in the second surface 12 of the first layer 10, with the second layer 20 being provided such that the first surface 21 conforms to the relief, or the diffractive relief structure 25 may have been formed in the first surface 21 of the second layer 20 with the first layer being provided thereover such that the second surface 12 conforms to the relief.

So that the diffractive relief structure 25 produces an optically variable effect, the second layer must be provided with a refractive index such that an appropriate refractive index difference exists across the boundary between the first 10 and second layers 20.

In this embodiment, no optical spacer layer is provided, and instead, the second layer 20 has a thickness which brings the second surface 22 of the second layer substantially in line with the focal plane of the lenses 15. The second surface 22 of the second layer 20 is provided with an array of microimage elements 30, which are substantially identical to the first and second embodiments, so that the same moiré magnified image is produced.

This embodiment of the security element 1 may appear substantially identical to the first and second embodiments. In this embodiment, the lenses may distort slightly the image displayed by the diffractive relief structure 25, however, this can be minimised to a virtually imperceptible level by providing the diffractive relief structure sufficiently far from the focal plane of the lenses 15. In practice, this may mean providing the first layer 10 as a relatively thin layer, such that the diffractive relief structure 25 is as close to the array of lenses 15 as possible. Additionally, the lack of any HRI layer on the diffractive relief structure 25 may mean that the replay brightness of the diffractive optical effect 26 is lessened in comparison to the previous embodiments.

A fourth embodiment will now be described with reference to FIG. 4. The fourth embodiment is similar to the third embodiment. In this embodiment, the first layer 10 is covered by a transparent overcoat layer 60. The overcoat layer 60 conforms to the lens relief structure in the first surface 11 of the first layer 10, and has a refractive index that provides a refractive index difference across the boundary with the first layer that gives the lenses 15 the desired focal length. The overcoat not only controls the refractive index difference at the lens relief boundary, but it also serves to protect the lenses from damage, for example, by abrasion.

A transparent HRI layer 50 is present between the first 10 and second layer 20, specifically, between the second surface 12 of the first layer 10 and the first surface 21 of the second layer 20. The HRI layer coats the diffractive relief structure formed in the first surface 21 of the second layer 20. Both surfaces of the HRI layer substantially match the shape of the diffractive relief structure in the second layer, and the second surface 12 of the first layer 10 conforms to the surface of the HRI layer 50 with which it is in contact, thereby also substantially matching the shape of the diffractive relief structure 25.

The security element of the fourth embodiment, may appear substantially identical to the third embodiment, however, the replay brightness of the diffractive optical effect may be increased by the HRI layer 50.

A security thread comprising the security element of the first embodiment will now be described with reference to FIG. 5. The security thread 2 comprises all of the layers provided in the first embodiment. Specifically, the thread 2 comprises a first layer 10 having an array of convex lenses, a second layer 20, over the first layer, having a diffractive relief structure, a HRI layer 50 coating the diffraction relief structure, an optical spacer layer 40 on the second surface 12 of the first layer 10, and an array of image elements 30 on the optical spacer layer. The thread 2 also includes a number of additional, optional layers, which will be described in turn.

The thread 2 comprises an additional transparent spacer layer 45 having opposed first and second surfaces 46, 47 located over the array of microimage elements 30. The additional transparent spacer layer 45 is located such that the microimage elements 30 are located between the first surface 46 of the additional transparent spacer layer 45 and the second surface 42 of the optical spacer layer 40.

The thread further includes a demetallised layer 70. The demetallised layer 70 is located on the second surface 47 of the additional spacer layer 45. The demetallised layer 70 is a layer of metal, which has been selectively demetallised, as is known in the art, to leave a series of gaps in the layer which, in this case, produce a clear text pattern. The demetallised layer 70 can add further visual complexity in that when the device is viewed in transmission, the demetallised layer 70 blocks out light in the regions in which the metal is present, and allows the light to transmit through the device in the demetallised regions. The demetallised layer 70 may thereby display patterns, or in this case text, when viewed in transmission.

The thread further includes a magnetic layer 75. The magnetic layer is located directly beneath the demetallised layer 70 as it is viewed in the Figure. The magnetic layer 75 comprises a pattern of magnetic material, which may, for example, provide a machine readable code.

Directly beneath the magnetic layer 75 (as viewed in the Figure) is an optically effective layer 80. The optically effective layer is a layer of transparent material, e.g. a polymeric resin, which comprises an optically effective substance, such as a visible colourant, or a luminescent, phosphorescent or fluorescent material. Such optically effective substances could additionally or alternatively be disposed in any of the other layers of this device, or the layers of the previous and subsequent embodiments. An optically effective layer may further enhance the security and visual complexity of the security element.

Finally, the thread 2 comprises transparent adhesive layers on both the uppermost and lowermost surfaces to facilitate its inclusion in or on a substrate, i.e. a first adhesive layer 86 is present on the reflection enhancing layer 50, and a second adhesive layer 87 is present beneath the optically effective layer 80.

It will be appreciated that the functions of the additional optical spacer layer 45, the demetallised layer 70, the magnetic layer 75, the optically effective layer 80, and the first and second adhesive layers 86, 87 complement one another in the production of a security element according to the invention, but they are all nevertheless separate, and any one layer may be incorporated with none, or one or more, of the other layers. Furthermore, the layers are not limited to inclusion in embodiments formed as threads, and any one layer may additionally be incorporated into any of the embodiments disclosed herein with none, or one or more, of the other layers.

A fifth embodiment will now be described with reference to FIG. 6. The structure of the security element is shown schematically in FIG. 6A. The security element comprises a first layer 10, which is substantially identical to the first layer of the first embodiment.

As in the first embodiment, a second layer 20 is provided directly on the first surface 11 of the first layer such that it conforms to the lens relief structure 15, and extends over the entire area of the element 1. In this embodiment, a diffractive relief structure 25 is provided over only part of the first surface 21 of the second layer. In particular, the diffractive relief structure 25 is provided in a region (the second region) whose boundary defines a letter ‘B’, as can be seen in FIG. 6B. The diffractive relief structure 25 is coated in an HRI layer 50, which, in this embodiment, is provided on the first surface of the second layer only where the diffractive relief structure 25 is present (i.e. only in the second region). However, the HRI layer could, alternatively, be provided over the entire first surface 21 of the second layer 20 without substantially affecting the appearance of the security element.

The security element 1 further includes an optical spacer layer 40 on the second surface 12 of the first layer, and an array of image elements 30, corresponding to the array of lenses 15 in the first layer, located on the lower surface of the optical spacer layer, as in the first embodiment.

When the security element is viewed, the viewer arranges the element so that the diffractive relief structure 25 and the array of lenses 15 are positioned between the viewer and the array of image elements 30. Under these viewing conditions, as with the first embodiment, two optically variable effects are visible to the viewer.

Firstly, a diffractive optical effect 26 (shown schematically as a series of diagonal dashed lines) is visible across the second region, i.e. the region whose perimeter defines a letter ‘B’. The diffractive relief structure 25 can again be configured to display many different types of images or patterns. In addition, the diffractive relief structure 25 may be configured to produce a simple colour change effect which forms an image by the provision of the relief structure across a select area. In this example, the diffractive optical effect defines, a colour shifting ‘B’ when the diffractive relief structure 25 is configured to generate a colour-shift effect. Alternatively, the second region can display an image within the boundary of the second region by varying the relief structure characteristics within the second region to for example vary the grating iridescence in accordance with an image. The result can be a complex holographic image within the B-shaped window defined by the perimeter of the second region.

In addition to the diffractive optical effect 26 displayed in the second region, the optically variable effect 16 produced by the lenses 15 in combination with the image elements 30 is visible superimposed with the diffractive optical effect 26. Because the second layer 20 (and HRI layer 50) is substantially transparent across the entire area of the security element, the optically variable effect produced by the lenses 15 is visible not only in the region of the diffractive optical effect 26, but across the entire area of the security element 1. As in the first embodiment, the effect shown in the Figure is a moiré magnification effect, however, it will be appreciated that other combinations of lenses and image elements could be used to generate other known, lens-based effects.

A sixth embodiment will now be described with respect to FIG. 7. The sixth embodiment comprises a first layer 10, which is substantially identical to the first layer of the first embodiment, over which is provided second layer 20, again substantially identical to the second layer of the first embodiment.

In this embodiment, an opaque reflection enhancing material 55, which is in this case a metal layer, selectively coats the diffractive relief structure 25 on the first surface 21 of the second layer 20. The opaque reflection enhancing material 55 defines in the regions where it is absent a transparent region (i.e. the second region) of the diffractive relief structure 25. The transparent region of the diffractive relief structure 25 defines a letter ‘B’. The opaque reflection enhancing material 55, wherever it is present, is coated with a clear resist layer 56. As will be described below, the clear resist layer defined regions of the reflection enhancing material 55 that were not to be removed as part of a demetallisation process. The upper surface of the element, i.e. the clear resist layer 56 and the uncoated regions of the diffractive relief structure 25, are overcoated in a transparent overcoat layer 60. Here the transparent overcoat layer 60 is provided with a refractive index that is different from the refractive index of the second layer 20, such that a refractive index difference exists across the boundary with diffractive relief structure 25 in the region where the opaque reflection enhancing material 55 is absent.

The security element 1 further includes an optical spacer layer 40 on the second surface 12 of the first layer, and an array of image elements 30, corresponding to the array of lenses 15 in the first layer, located on the lower surface of the optical spacer layer, as in the first embodiment.

When the security element is viewed, the viewer again arranges the element so that the diffractive relief structure 25 and the array of lenses 15 are positioned between the viewer and the array of image elements 30.

As shown in FIG. 7B, the device exhibits a diffractive optical effect 26 across the entire region in which the diffractive relief structure 25 is provided, which in this case is the entire area of the security element 1. The opaque reflection enhancing material 55 defines, in the region of its absence, a substantially transparent region of the diffractive relief structure 25. The diffractive optical effect 26 has higher replay brightness in the region in which the opaque reflection enhancing material 55 is present than in the region in which it is absent, but is nevertheless visible across the entire area of the security element.

In the region in which the opaque reflection enhancing material 55 is absent, the device is substantially transparent, and so the optical effect 16 produced by the lenses 15 in combination with the image elements 30 (which are both located behind the diffractive relief structure 25 during viewing) is visible superimposed with the diffractive optical effect 26. The partial obscuring of the optical effect 16 produced by the lenses 15 provides a more complex, visually striking appearance of the security element. Furthermore, the opaque reflection enhancing material 55 provides that, when viewed in transmission, the transparent region, which in this case defines a ‘B’, stands out from its surroundings, thereby providing an additional means of authentication.

A seventh embodiment will now be described with respect to FIG. 8. The seventh embodiment comprises a first layer 10, which is substantially identical to the first layer of the first embodiment.

Over the first layer 10, directly in contact with the first surface 11 of the first layer 10 and conforming to the lens relief structure 15, is provided a discontinuous second layer 20. The second layer 20 is provided only over a region of the security element, the region in this case defining a letter ‘B’. The discontinuous second layer 20 has opposing first 21 and second 22 surfaces, the second surface being the one in contact with the first surface 11 of the first layer 10. The refractive indices of the first and second materials are selected in combination with the lens dimensions, such that lenses coated in the second layer 20 have the desired focal length.

The first surface 21 of the second layer 20 has formed therein a diffractive relief structure 25. In this embodiment, the diffractive relief structure 25 is provided across the entire first surface 21 of the second layer (in as far as it is provided), however, in alternative embodiments, the diffractive relief structure 25 may be provided in only a partial region of the first surface 21 of the second layer 20.

The diffractive relief structure 25 is coated in a transparent HRI layer 50, which provides a large refractive index difference at the boundary of the first surface 21 of the second layer 20 to increase the replay brightness of the optically variable effect generated by the diffraction relief structure.

The security element 1 further includes an optical spacer layer 40 on the second surface 12 of the first layer, and an array of image elements 30, corresponding to the array of lenses 15 in the first layer, located on the lower surface of the optical spacer layer, as in the first embodiment. While not provided in this embodiment, the exposed region of the first layer 10 and the second layer 20 could optionally be provided with an overcoat layer.

When the security element is viewed, the viewer again arranges the element so that the diffractive relief structure 25 and the array of lenses 15 are positioned between the viewer and the array of image elements 30.

In the region in which the second layer is provided, a diffractive optical effect 26 is produced by the diffractive relief structure 25, as has been described above. Furthermore, the transparency of the second layer 20 and the HRI layer 50 provide that the optically variable effect produced by the lenses 15 in combination with the image elements 30 is visible superimposed with the diffractive optical effect 26 in the region in which the second layer 20 is provided. In the region in which the second layer 20 is absent, the refractive index difference across the boundary of the array of lenses 15 is such that the focal points of the lenses do not lie in the plane of the array of microimages 30, and so a moiré magnification effect is not produced. The result is a substantially transparent security element, which has two superimposed optically variable effects in the same partial region of the element 1.

An eighth embodiment will now be described with reference to FIG. 9. The eighth embodiment comprises a first layer 10, which is substantially identical to the first layer of the first embodiment, over which is provided second layer 20, again substantially identical to the second layer of the first embodiment.

In this embodiment, an opaque reflection enhancing material 55, which is in this case a metal layer, selectively coats the diffractive relief structure 25 on the first surface 21 of the second layer 20. The opaque reflection enhancing material 55 defines in the regions where it is present an opaque region in which the second image is displayed (i.e. the second region).

In this embodiment the opaque region of the diffractive relief structure 25 defines a letter ‘B’. The opaque reflection enhancing material 55, wherever it is present, is coated with a clear resist layer 56. The upper surface of the element, i.e. the clear resist layer 56 and the uncoated regions of the diffractive relief structure 25, are overcoated in a transparent overcoat layer 60. Here the transparent overcoat layer 60 is provided with a refractive index that is substantially the same as the refractive index of the second layer 20, such that no refractive index difference exists across the boundary with diffractive relief structure 25 in the region where the opaque reflection enhancing material 55 is absent.

The security element 1 further includes an optical spacer layer 40 on the second surface 12 of the first layer, and an array of image elements 30, corresponding to the array of lenses 15 in the first layer, located on the lower surface of the optical spacer layer, as in the first embodiment.

When the security element is viewed, the viewer again arranges the element so that the diffractive relief structure 25 and the array of lenses 15 are positioned between the viewer and the array of image elements 30.

As shown in FIG. 9B, the element exhibits only the diffractive optical effect 26 in the regions in which the opaque reflection enhancing material is present. Where the opaque reflection enhancing material 55 is absent, the element exhibits only the optical effect 16 produced by the lenses 15 in combination with the image elements 30 is visible. These two images are visible adjacent and simultaneously but do not overlap or appear superimposed. Instead, the optical effect 16 produced by the lenses appears immediately outside of the region in which the diffractive optical effect 26 is visible.

While in the eighth embodiment, the diffractive optical effect 26 is suppressed by overcoating the diffraction relief structure with a transparent overcoat layer 60 of substantially similar refractive index, other methods of achieving the same effect are possible. For example, the diffractive relief structure 25 may be provided only in a partial region of the security element, as in the fifth embodiment, and then overcoated with an opaque reflection enhancing layer 55 in that same partial region.

A ninth embodiment will be described with reference to FIG. 10. The ninth embodiment comprises a first layer 10, which is substantially identical to the first layer of the first embodiment, over which is provided second layer 20. In this embodiment, the second layer 20 is provided with a substantially flat upper surface 21. That is to say, no diffractive relief structure is embossed in the upper surface of the second layer. On the upper surface of the second layer 20 is provided an array of microprisms, in this case a series of pyramidal facets in the form of a prismatic film, selectively applied over the surface of the second layer 21. While pyramidal facets are shown here, other prismatic structures may be used. The facets are shown in this embodiment applied in a region defining a letter ‘B’, as in the previous embodiments.

The security element 1 further includes an optical spacer layer 40 on the second surface 12 of the first layer, and an array of image elements 30, corresponding to the array of lenses 15 in the first layer, located on the lower surface of the optical spacer layer, as in the first embodiment.

A tenth embodiment will now be described with reference to FIG. 11. The tenth embodiment is substantially the same as the fifth embodiment. The tenth embodiment differs from the fifth embodiment in that the diffractive relief structure 25 is provided with a first pitch and thickness in a first area 25A and with a second pitch and thickness in a second area 25B such that the first and second areas have different appearances. For example, if the first area 25A described a first letter ‘B’ and the second area 25B described a second letter ‘B’, the first and second letters might appear a different colour owing to the difference in the characteristics of the diffraction relief structure. It will be appreciated that these characteristics may be varied continuously within a region, as well as discretely between regions.

A security document 90 incorporating the security element according to the first embodiment is shown in FIG. 12. The security document 90 is formed of a polymeric substrate 95, which in this case is biaxially oriented polypropylene (BOPP), having opposing first and second surfaces 91, 92. The security element 1 is provided in a region of the security document 90.

The security element may be provided as a complete structure applied to one side of the security document, as is shown in FIG. 12B. In this case, the lowermost surface of the security element, which in this case is the surface of the optical spacer layer 40 on which a printed array of microimages 30 is provided, is provided directly on the first surface 91 of the polymeric substrate 95, preferably being adhered thereto by an adhesive layer (not shown).

Alternatively, the polymeric substrate 95 of the security document may be provided as one of the layers of the security element, e.g. as any one of the first layer 10, second layer 20, or optical spacer layer 40 (as shown in FIG. 12C). Where the polymeric substrate 95 of the security document serves as one of the first or second layers, the lens relief structure 15 and/or diffractive relief structure should be formed in the first and/or second surface 91, 92 of the polymeric substrate.

While the security document of FIG. 12 is shown as incorporating the first embodiment of the security element, it will be appreciated that any of the above described embodiments could be similarly incorporated into a security document.

Methods of manufacturing the security elements, such as those above, will now be described. A first embodiment of a method according to the present invention will now be described in detail with reference to FIG. 13.

A continuous web of carrier material 101 supported at a number of points along its length by rollers 102. In the figures, the continuous web of carrier material is shown as extending along a substantially straight path for ease of understanding, however, it will be appreciated that typically the path the web of carrier material follows will change direction, for example, by wrapping part-way around one or more of the rollers 102 or by wrapping part-way around one or more of the cylinders (described below) which has the advantage of increasing the materials contact time with the cylinders. In this embodiment, the carrier is an endless web of polyethylene terephthalate (PET), which will serve as an optical spacer layer 40 in the manufactured security element.

At a primer layer application position 142 a primer layer application system 141 applies a primer layer 145 to the upper surface of the web of carrier material 101. The primer layer application system 141 comprises an applicator 143 and a cylinder 144. The applicator continuously applies a coating of the primer layer 145 to the continuously rotating cylinder 144. As the cylinder rotates, it brings the primer layer 145 towards the primer layer application position 142, at which the primer layer is brought into contact with the web of carrier material 101 as the web is transported along the web direction. The primer layer is transferred on to the upper surface of the carrier material 101, and the web continues along, away from the primer layer application position 142 and towards a first material application position 112. While an primer layer is applied in this embodiment, alternatively or in addition, an adhesive layer could be applied to the upper surface of the web of carrier material.

At a first material application position 112, a first, curable resin (first material) 110 is applied to the upper surface of the web of carrier material 101, onto the primer layer 145, by a first material application system 111. The formulation of suitable resins will be described in greater detail below. The first material application system 111 comprises a first applicator 113 and a first cylinder 114 located above the endless web 101. The applicator continuously applies a coating of the resin 110 to the continuously rotating cylinder 114. As the cylinder rotates, it brings the resin 110 towards the first material application position 112, at which the resin is brought into contact with the primer layer on the web of carrier material 101 as the web is transported along the web direction. The resin is transferred on to the upper surface of the carrier material 101, and the web continues along, away from the first material application position 112 and towards a first casting position 116.

At the first casting position 116, the first, curable resin is cast so that a lens relief structure is formed in its upper surface. The casting is performed by a rotating casting cylinder 115. The casting cylinder 115 has a surface shaped to be the conjugate of the desired lens relief structure. In this embodiment, the casting cylinder 115 has a surface which comprises an array of concavities arranged and sized to produce a regular, two-dimensional array of convex lenses in the upper surface of the first material 110. Alternatively, a casting cylinder whose surface comprises an array of hemisphere may be used to form an array of concave lenses, and so forth for concave and convex cylindrical or aspherical lenses. As the casting cylinder 115 rotates, it continuously forms the lens relief structure in the surface of the first material 110 on the moving web of carrier material 101. The web of carrier material continues away from the casting cylinder 115, having had the lens relief structure pressed into its upper surface, to a first curing position 118. At the first curing position 118, the upper surface of the first, curable material 110 is exposed to light from a first ultraviolet light source 119 such that the first, curable material 110 is cured, fixing the lens relief structure in its upper surface. While in this embodiment, the curing position is shown as downstream of the first casting position 116 for ease of understanding, the curing position could more preferably be provided at the first casting position 116. In such embodiments, ultraviolet light source 119 may be provided in the centre of a transparent casting cylinder (as is known in the art), or beneath the web of a transparent carrier material and configured to expose the curable material to curing radiation via the transparent carrier material while it is in contact with the casting cylinder.

The web of carrier material 101, now having on its upper surface cured material 110, in which is formed a lens relief structure, continues away from the first curing position 118, to a second material application position 122. At the second material application position 122, a second, curable resin 120 is applied over the upper surface of the first material 110 by a second material application system 121. The second material application system 121 is structured similarly to the first, and comprises a second applicator 123 and a second cylinder 124 located above the web of carrier material 101 and first material 110. The applicator continuously applies a coating of resin 120 to the continuously rotating second cylinder 124. As the cylinder rotates, it brings the resin 120 towards the second material application position 122, at which the resin is brought into contact with the upper surface of the first material 110, on the web of carrier material 101, as the web is transported along the web direction. The resin is transferred on to the upper surface of the first material 110, where, owing to its relatively low viscosity in its uncured state, it conforms to the lens relief structure in the upper surface of the first material 110. The web continues along, away from the second material application position 122 and towards a second casting position 126.

At the second casting position 126, the second, curable resin (second material) 120 is cast so that a diffraction relief structure is formed in its upper surface. The casting is performed by a rotating casting cylinder 125. The casting cylinder 125 has a surface shaped to be the conjugate of the desired diffraction relief structure, which may be any diffraction relief structure, including diffraction gratings, holograms and Kinegrams. As the casting cylinder 125 rotates, it continuously forms the diffraction relief structure in the surface of the second material 120 on the moving web of carrier material 101. The web of carrier material continues away from the casting cylinder 125, having had the diffraction relief structure pressed into its upper surface, to a second curing position 128.

At the second curing position 128, the upper surface of the second, curable material 120 is exposed to light from a second ultraviolet light source 129 such that the second, curable material 120 is cured, fixing the diffraction relief structure in its upper surface, fixing the lower surface in conformity with the lens relief structure in the first material 110, and bonding the two layers together. As mentioned above, the second curing position could alternatively be concurrent with the second casting position.

The web of material 101 is then conveyed along, away from the apparatus shown in FIG. 13, where it may be processed further. In the case of the present embodiment, processing further comprises, printing an array of microimage elements on the lower surface of the web, which may be performed using conventional printing techniques such as gravure printing, lithographic printing, flexographic printing, offset printing or screen printing processes. Alternatively, processing further may include embossing means to define the image elements using diffraction relief structures or arrays of nanostructures, which may subsequently be metalized, or a system for forming a discontinuous metal layer for defining the image elements. This system may comprise, for example, a means for metalizing the upper surface of the optical spacer layer, an application system for applying a photosensitive resist material, a mask and radiation source for selectively exposing the photosensitive resist material to radiation and means for exposing the structure to an etchant for etching the photosensitive resist material and metal layer to define the array of image elements. Such a system may be substantially as disclosed in WO 2016/198876 A1. Processing further also includes coating the diffraction relief structure formed in the upper surface of second material 120 in a transparent HRI layer by, for example, vacuum deposition or physical vapour deposition. Additionally, any of the optional layers described above with respect to the thread incorporating the security element of the first embodiment may be provided after manufacture as described with respect to FIG. 13. Finally, the web of security material may be divided up into individual security elements, for example by cutting.

Examples of suitable materials for forming, in particular, the transparent first and second layers 110 and 120 (first and second layers 10 and 20 of embodiments of FIGS. 1 to 12), as well as other transparent layers such as the optical spacer layers, will now be provided. For a simple transparent material, just one of the material components indicated below could be used, but more usually, the material will comprise a mixture (co-polymer or blend) of two or more of the components listed, in order to achieve not only the required optical properties but also desirable mechanical properties. The “high refractive index” materials listed below have a refractive index of about 1.55 or more, and the “low refractive index” materials about 1.45 or less. It will be appreciated that the refractive indices of the materials can be selected by the skilled person to produce lenses which operate as desired, with a specific focal length. Where available, the approximate refractive index (RI) of each component is indicated below. In the above embodiments, both of the materials also comprise a curable component and examples of these are provided below. However it is noted that in some embodiments of the present invention, the materials need not be curable.

### Examples of High Refractive Index Components—

### Metal Containing Acrylates:

zirconium acrylate (Sigma Aldrich Cat. No. 686239)
hafnium acrylate (Sigma Aldrich Cat. No. R686212)
zirconium carboxyethyl acrylate (Sigma Aldrich Cat. No. 686247)
hafnium carboxyethyl acrylate (Sigma Aldrich Cat. No. 686220)

### Fluorene Acrylates Based Monomers—

(Miramer is a trade name of Miwon Chemicals, Korea)—

### Miramer HR6040

### Miramer HR6042

### Miramer HR6060

### Miramer HR6100

### High RI Nano Particulate Dispersions—

### Unidic EPC-1027 (DIC Corporation, Japan)

### SHR 1075 (Miwon Chemicals, Korea)

### Sulfur Containing Acrylate—

Phenylthioethyl acrylate, (Dichem Korea)—RI 1.560
1-naphthylthio ethyl acrylate (Dichem Korea)—RI 1.61

### Standard Acrylates—

Miramer M240 (Bisphenol A ethoxylated acrylate)—RI 1.537

### Miramer M2100 (Phenoxy Benzyl Acrylate)—RI 1.565

Miramer M1142 (1-Ethoxylated-o-phenylphenol acrylate)—RI 1.577

### Miramer HR2582 (Urethane Acrylate)—RI-1.595

Miramer HR2200 (Epoxy acrylate)—RI-1.559
Miramer HR3000 (Urethane acrylate)—RI 1.571
Miramer HR3200 (Urethane acrylate)—RI 1.565
Miramer HR3700 (Urethane acrylate)—RI 1.585
Miramer HR3800 (Urethane acrylate)—RI 1.573
HR4000 (Urethane acrylate, RI 1.582)

### Examples of Low Refractive Index Components:

Fluoro-Acrylate Monomers from the Following—
PDFA—pentadecafluorooctyl acrylate—RI 1.3390
TFA=2,2,2-trifluoroethyl acrylate
HFBA—heptafluorobutyl acrylate—RI 1.3670
HDFA=1H,1H,2H,2H-heptadecafluorodecyl acrylate,
HFIPA=hexafluoroisopropy acrylate,
TDFA=1H, 1H,2H,2H-tridecafluorooctyl acrylate
Tetrafluoro-3-(heptafluoropropoxy)propyl acrylate—RI 1.3460
Tetrafluoro-3-(pentafluoroethoxy)propyl acrylate—RI 1.3480

### Tetrafluoroethylene—RI 1.3500

Undecafluorohexyl acrylate—RI 1.3560
Nonafluoropentyl acrylate—RI 1.3600
Tetrafluoro-3-(trifluoromethoxy)propyl acrylate—RI 1.3600
Pentafluorovinyl propionate—RI 1.3640
Trifluorovinyl acetate—RI 1.3750
Octafluoropentyl acrylate—RI 1.3800
Methyl 3,3,3-trifluoropropyl siloxane—RI 1.3830
Pentafluoropropyl acrylate—RI 1.3850

### 1H,1H-Heptafluorobutyl(meth)acrylate,

### 1H, 1H,5H-octafluoropentyl(meth)acrylate,

### 2,2,3,4,4,4-Hexafluorobutyl(meth)acrylate,

perfluorooctylethyl(meth)acrylate,
trifluoroethyl (meth)acrylate,
trifluoroethyl(meth)acrylate, and
perfluorooctylethyl(meth)acrylate

### Preferred Commercially Available Examples Include:

Defensa OP-188 (from DIC Japan)

### Defensa OP-3801

### Defensa OP-4002

### Defensa OP-4003,

### Defensa OP-4004,

Sartomer CN 4002 (from Sartomer)
Viscoat 8F (from Kowa Europe GmbH)

### Viscoat 3F

Fluorolink® MD 700 (from Solvay Solexis Inc.),

### Fluorolink® MD 500, and

### Fomblin® MD 40

The high refractive index formulation and the low refractive index formulation may each optionally further include one or more components with higher functionality (meaning in this case a higher number of acrylic groups in the material), to increase the degree of cross-linking, which leads to reduced tackiness and improved mechanical properties. Examples of suitable higher functional acrylate components include:

trimethylolpropane triacrylate,
pentaerythritol triacrylate,
ethoxylated (3) trimethylolpropane triacrylate,
ethoxylated (3) trimethylolpropane triacrylate,
propoxylated (3) trimethylolpropane triacrylate,
ethoxylated (6) trimethylolpropane triacrylate,
tris(2-hydroxy ethyl) isocyanurate triacrylate,
dipropylene glycol diacrylate,
propoxylated (3) glyceryl triacrylate,
propoxylated (3) glyceryl triacrylate,
pentaerythritol tetraacrylate.

A curing agent is also included in both of the formulations. A range of suitable photo- and thermo-initiators are commercially available. Photo-polymerisation is preferred for the current application due to faster cure, although thermo initiation can also be used. Some examples of suitable free radical type photo-initiators are given below:

1-phenyl-2-hydroxy-2-methyl-1-propanone,
2 hydroxy 2-methyl 1-phenyl propan-1-one,
2,2-dimethoxy-1,2-di(phenyl)ethanone
1-hydroxycyclohexyl phenyl ketone,
benzophenones,
bis-acyl phosphine oxide (BAPO),
aminoketones,
thioxanthones,
(2,4,6-trimethylbenzoylphenyl phosphinate),
2-Benzyl-2-(dimethylamino)-1-[4-(4-morpholinyl)phenyl]-1-butanone

A preferred example formulation of a high refractive index transparent material is:

### 40 wt % DIC Unidic EPC 1027,

### 30 wt % Miramer HR 6042,

### 25 wt % Miramer HR3700.

5 wt % Photo-initiators and common surface active additives

A preferred example formulation of a low refractive index transparent material is:

### 50 wt % Defensa OP-188

### 30 wt % Viscoat 8F

15 wt % Ethoxylated (3) trimethylolpropane triacrylate,
5 wt % Photo-initiators and additives

A second embodiment of a method according to the invention will now be described with reference to FIG. 14.

The second embodiment of the method according to the invention is similar to the first, and comprises providing a continuous web of carrier material 101 supported at a number of points along its length by rollers 102. Again, the carrier material is an endless web of polyethylene terephthalate (PET), however, in this embodiment, the web of material is intended to be removed from the manufactured security element.

At a release layer application position 147 a release layer application system 146 applies a release layer 150 to the upper surface of the web of carrier material 101. The release layer application system 146 is structurally identical to the primer layer application system 141 of the first embodiment of the method according to the invention in that it comprises a release layer applicator 148 and roller 149, and operates as described above, but instead applies a release layer 150, such as a wax, to the surface of the web of carrier material 101. The release layer provides that the security element may be removed from the layer of carrier material 101 after at least one of the other layers has been formed.

After the release layer is transferred on to the upper surface of the carrier material 101, the web continues along, away from the release layer application position 147 and towards a second material application position 122.

At the second material application position 122, a second, curable resin 120 is applied over the upper surface of web of carrier material 101, onto the release layer 150 by a second material application system 121. The second material application system 121 is structured identically to the second material application system of the first embodiment of the method according to the invention, and operates as described above, applying the second material over the upper surface of web of carrier material 101. The web continues along, away from the second material application position 122 and towards a second casting position 126.

At the second casting position 126, the second, curable resin 120 is cast so that a diffraction relief structure is formed in its upper surface. The casting is performed by a rotating casting cylinder 125. The casting cylinder 125 has a surface shaped to be the conjugate of the desired diffraction relief structure, which may be any diffraction relief structure, including diffraction gratings, holograms and Kinegrams. As the casting cylinder 125 rotates, it continuously forms the diffraction relief structure in the surface of the second material 120 on the moving web of carrier material 101. The web of carrier material continues away from the casting cylinder 125, having had the diffraction relief structure pressed into its upper surface, to a second curing position 128.

At the second curing position 128, the upper surface of the second, curable material 120 is exposed to light from a second ultraviolet light source 129 such that the second, curable material 120 is cured, fixing the diffraction relief structure in its upper surface. The web then continues along, away from the second curing position 128 to a first material application position 112.

At the first material application position 112, a first, curable resin 110 is applied to the upper surface of the layer of second material 120 by a first material application system 111. The first material application system 111 is structured identically to the first material application system of the first embodiment of the method according to the invention, and operates as described above, now applying a layer of first material 110 over the upper surface of the layer of second material 120, directly onto the diffraction relief structure formed in the upper surface of the layer of second material, where, owing to its relatively low viscosity in its uncured state, it conforms to the diffraction relief structure in the upper surface of the second material 120.

The web 101 continues towards a first casting position 116. At the first casting position 116, the first, curable resin is cast so that a lens relief structure is formed in its upper surface. The casting is performed by a rotating casting cylinder 115. The casting cylinder 115 has a surface shaped to be the conjugate of the desired lens relief structure, which in this case is a relief defining a two-dimensional array of spherical lenses, but again could be any array of lenses.

The web of carrier material continues away from the casting cylinder 115, having had the lens relief structure pressed into its upper surface, to a first curing position 118. At the first curing position 118, the upper surface of the first, curable material 110 is exposed to light from a first ultraviolet light source 119 such that the first, curable material 110 is cured, fixing the lens relief structure in its upper surface, fixing the lower surface in conformity with the diffraction relief structure in the second material 120, and bonding the two layers together.

The web of material 101 is then conveyed along, away from the apparatus shown in FIG. 14, where it may be processed further. The additional processing steps may include any of those described above with respect to the first embodiment of the method according to the invention. Additionally, it may comprise overcoating the lenses with an additional curable layer and curing, thereby providing the lenses with a protective overcoat.

It will be noted that the embodiment described with respect to FIG. 14 did not include applying a HRI coating to the diffractive relief structure before application of the layer of first material. In alternative embodiments, the web of carrier material is subject to, the optional application of a release layer, followed by application of the second material and cast-curing of the second material, as described above with respect to FIG. 14. The diffractive relief structure is then coated in an HRI layer, for example by vacuum deposition or physical vapour deposition, before having the first material applied and cast cured as also described above with respect to FIG. 14.

The above embodiments of methods according to the invention describe all layers being applied substantially continuously to an endless web of carrier material. However, this is not essential, and one or more of the layers may be applied discontinuously, and/or the processes performed selectively, as will be described below.

A third embodiment of a method according to the invention is shown in FIG. 15. The third embodiment of the method according to the invention is similar to the first, and comprises providing a continuous web of carrier material 101 supported at a number of points along its length by rollers 102. Again, the carrier material is an endless web of polyethylene terephthalate (PET) which will serve as an optical spacer layer in the manufactured security element.

At an primer layer application position 142, a continuous primer layer 145 is applied in an identical manner to the first embodiment of the method according to the invention.

At a first material application position 112, a first material application system 111, which is identical to the first material application system 111 of the first embodiment of the method according to the invention, applies separate regions of first, curable resin material 110 to the upper surface of the web of carrier material 101. The first material applicator 113 applies the first material 110 to the roller 114 in discrete regions, and these are transferred onto the carrier material as the first material is brought into contact with the carrier material through rotation of the roller.

The discrete regions of first material are conveyed away from the first material application position 112 by the web of carrier material to a first casting position 116. At the first casting position 116, the first, curable material 110 is cast so that a lens relief structure is formed in its upper surface. The casting is performed by a rotating casting cylinder 115. In this case the entire upper surface of the first curable material, in as far as it is provided, is cast with the lens relief structure, however, it will be appreciated that the lens relief structure may be provided in only select regions of the first material by configuring the surface of the casting cylinder 115 accordingly. Alternatively, an embossing stamp or other such means may be used to form the desired surface relief in a discrete area of the surface of the layer of first material. The casting cylinder 115 in this embodiment has a surface shaped to produce a relief defining a two-dimensional array of spherical lenses, but again any array of lenses could be defined.

The web of carrier material continues away from the casting cylinder 115, having had the lens relief structure pressed into its upper surface, to a first curing position 118. At the first curing position 118, the upper surface of the first, curable material 110 is exposed to light from a first ultraviolet light source 119 such that the first, curable material 110 is cured, fixing the lens relief structure in its upper surface.

The web of carrier material 101, now having on its upper surface cured material 110, in which is formed a lens relief structure, continues away from the first curing position 118, to a second material application position 122. At the second material application position 122, a second, curable resin 120 is applied over the upper surface of the first material 110 by a second material application system 121. The second material application system 121 is identical to that of the first embodiment of the method according to the invention, and applies discontinuous and/or discrete regions of the second, curable material 120 to the upper surface of each region of the first material 110. This is achieved by using the second material applicator 123 to apply discontinuous and/or discrete regions of second material 120 to the surface of the roller 124, which are then brought into contact with the first material carried by the web 101 through rotation of the roller 124. The resin is then transferred on to the upper surface of the first material 110, where, owing to its relatively low viscosity in its uncured state, it conforms to the lens relief structure in the upper surface of the first material 110. The web continues along, away from the second material application position 122 and towards a second casting position 126.

At the second casting position 126, the layer of second, curable material 120, in as much as it is provided, is cast so that a diffraction relief structure is formed in its upper surface. The casting is performed, again, by a rotating casting cylinder 125. In this case the entire upper surface of the second curable material, in as far as it is provided, is cast with the diffraction relief structure, however again, it will be appreciated that the diffraction relief structure may be provided in only select regions of the second material by configuring the surface of the casting cylinder 125 accordingly. Alternatively, an embossing stamp or other such means may be used to form the desired surface relief in a discrete area of the surface of the layer of second material. The web of carrier material continues away from the casting cylinder 125, having had the diffraction relief structure pressed into its upper surface, to a second curing position 128.

At the second curing position 128, the upper surface of the second, curable material 120 is exposed to light from a second ultraviolet light source 129 such that the second, curable material 120 is cured, fixing the diffraction relief structure in its upper surface, fixing the lower surface in conformity with the lens relief structure in the first material 110, and bonding the two layers together.

Methods of applying a reflection enhancing layer will now be described with reference to FIGS. 16 and 17.

FIG. 16A shows a security element according to the fifth embodiment before application of the HRI layer 50, i.e. with the diffraction relief structure 25 in the upper surface of the second layer 20 exposed. This security element may, for example, have been produced using a method substantially as described with respect to FIG. 13.

In order to apply a partial covering of the first surface 21 of the second layer 20 with a HRI layer, first a soluble masking layer 51, which is preferably water soluble, is applied over the first surface 21 of the second layer 20 in the regions in which the HRI layer 50 should not be provided in the finished security element. This is shown in FIG. 16B.

The HRI layer 50 is then applied over the entire upper surface of the security element, i.e. over the first surface 21 of the second layer 20 where it is exposed and otherwise over the soluble masking layer 51. As described above, this application of HRI layer 50 will typically be performed by vacuum deposition or physical vapour deposition. The security element so coated in HRI layer 50 is shown in FIG. 16C.

The soluble masking layer 51 is then removed by washing the security element in the appropriate solvent. Removal of the soluble masking layer 51 also removes the HRI layer 50 where it coats the soluble masking layer 51 but leaves the HRI layer 50 where it coats the first surface 21 of the second layer 20. The security element after removal of the soluble masking layer 51 is shown in FIG. 16D.

FIG. 17A shows a security element according to the sixth embodiment, before application of the opaque reflection enhancing layer 55, clear resist layer 56, and overcoat layer 60, i.e. with the diffraction relief structure 25 in the upper surface of the second layer 20 exposed. This security element may, for example, have been produced using a method substantially as described with respect to FIG. 13.

The substantially opaque reflection enhancing layer 55 is applied over the entire upper surface of the security element, i.e. coating the entire upper surface 21 of the second layer 20 and the diffraction relief structure 25 formed therein, as shown in FIG. 17B.

A clear resist layer 56 is then applied over the opaque reflection enhancing layer 55 coating the upper surface of the security element 1. The clear resist layer 56 is applied only to those areas in which the opaque reflection enhancing layer 55 should be present in the finished security element, leaving the opaque reflection enhancing layer 55 exposed elsewhere, as shown in FIG. 17C.

A demetallisation process is then performed to remove the opaque reflection enhancing coating 55 where it is not coated by the clear resist layer 56. The demetallisation process may, for example, comprise etching the exposed reflection enhancing layer 55 using an appropriate solvent. The result is that the opaque reflection enhancing coating 55 is removed from the first surface 21 of the second layer 20 where it is not coated by the clear resist layer 56, and otherwise retained beneath the clear resist layer 56 on the first surface 21 of the second layer 20. The resulting security element may then be provided with an overcoat layer 60 to arrive at the security element of FIG. 7.

In all of the above examples, image elements could be formed in a variety of ways. Above, printed image elements are described, together with those defined by a discontinuous metal layer. Image elements defined by relief structures are also described, with the examples given above including diffraction relief structures and nanostructures, such as moth-eye structures. FIG. 18 shows a variety of relief structures suitable for defining image elements. FIG. 18A illustrates image elements (IM), in the form of embossed or recessed regions while the non-embossed portions correspond to the non-imaged regions of the elements (NI). FIG. 18B illustrates image regions of the elements in the form of debossed lines or bumps.

In another approach, the relief structures can be in the form of diffraction gratings (FIG. 18C) or moth eye/fine pitch gratings (FIG. 18D). Where the image elements are formed by diffraction gratings, then different portions (either within one image element or in different elements) can be formed by gratings with different characteristics. The difference may be in the pitch of the grating or rotation. This can be used to achieve a multi-colour diffractive image which will also exhibit an optically variable effect such as an animation through the mechanisms described above. A preferred method for writing such a grating would be to use electron beam writing techniques or dot matrix techniques.

Such diffraction gratings for moth eye/fine pitch gratings can also be located on recesses or bumps such as those of FIGS. 18A and 18B, as shown in FIGS. 18E and 18F respectively.

FIG. 18G illustrates the use of a simple scattering structure providing an achromatic effect.

Further, in some cases the recesses of FIG. 18A could be provided with an ink or the debossed regions or bumps in FIG. 18B could be provided with an ink. The latter is shown in FIG. 18H where ink layers 410 are provided on bumps 400. Thus the image areas of each image element could be created by forming appropriate raised regions or bumps in a resin layer provided on a transparent substrate such as the optical spacer layer 40. This could be achieved for example by cast curing or embossing. A coloured ink is then transferred onto the raised regions typically using a lithographic, flexographic or gravure process. In some examples, some image elements could be printed with one colour and other image elements could be printed with a second colour to add further complexity to the optical effect provided.

Finally, FIG. 18I illustrates the use of an Aztec structure.

1. A security element comprising:
a first layer, the first layer having opposing first and second surfaces, and being formed of a substantially transparent first material having a first refractive index, the first surface of the first layer having formed therein, in a first region, an array of focussing elements;
an optically variable effect generating structure located over the first layer in a second region at least partially overlapping the array of focussing elements in the first region; and
an array of image elements arranged over the array of focussing elements such that a first image, formed from at least some of the image elements, is displayed to a viewer viewing the image elements via the array of focussing elements of the first layer;
wherein the optically variable effect generating structure is configured to display, in the second region, a second image to the viewer.

2. A security element according to claim 1, wherein:
the optically variable effect generating structure is substantially transparent in the second region such that the first image is displayed in at least the region of the overlap of the first and second regions to a viewer viewing the image elements via both the array of focussing elements of the first layer and the optically variable effect generating structure, and such that the second image is displayed in the second region to the viewer viewing the image elements via both the array of focussing elements of the first layer and the optically variable effect generating structure, one of the first image and the second image being displayed to the viewer superimposed on the other in the region of the overlap of the first and second regions.

3. A security element according to claim 1, wherein the first and second images are visible separately and simultaneously.

4. A security element according to claim 1, wherein the optically variable effect generating structure is substantially opaque in the second region.

5. A security element according to claim 1, further comprising one or more substantially transparent optical spacer layers, each having respective opposing first and second surfaces, disposed between the first layer and the array of image elements, and/or between the first layer and the optically variable effect generating structure.

6. (canceled)

7. A security element according to claim 1, wherein the optically variable effect generating structure is located between the first layer and the array of image elements.

8. A security element according to claim 1, wherein the first layer is located between the optically variable effect generating structure and the array of image elements.

9. A security element according to claim 7, wherein the optically variable effect generating structure comprises a diffractive relief structure formed in the second surface of the first layer in at least the second region.

10. A security element according to claim 1, wherein the optically variable effect generating structure comprises:
a second layer, the second layer having opposing first and second surfaces; and
a diffractive relief structure formed in the first surface of the second layer in at least the second region.

11. A security element according to claim 10, wherein the second surface of the second layer is in contact with the first surface of the first layer, the second surface of the second layer conforming to the array of focussing elements formed in the first surface of the first layer.

12. A security element according to claim 10, wherein the second layer is formed of a substantially transparent second material and the second layer is present over the entire first region.

13. A security element according to claim 9 wherein the diffractive relief structure is at least partially coated in a reflection enhancing material.

14. (canceled)

15. (canceled)

16. A security element according to claim 1, wherein the optically variable effect generating structure comprises a hologram or a reflective and/or refractive relief structure.

17. A security element according to claim 10, wherein the second surface of the first layer is located directly on the first surface of the second layer or, wherein the diffractive relief structure is at least partially coated in a reflection enhancing material and the second surface of the first layer is located directly on the reflection enhancing material coating the first surface of the second layer.

18. A security element according to claim 4, wherein the diffractive relief structure is partially coated in a substantially opaque reflection enhancing material, such as a metal layer, the second region being the region of the diffractive relief structure coated in the substantially opaque reflection enhancing material.

19. (canceled)

20. A security element according to claim 1, wherein the second region comprises a plurality of discrete sub-regions.

21. (canceled)

22. (canceled)

23. A security element according to claim 1, wherein the array of focussing elements is an array of lenses formed by a lens relief in the first surface of the first layer.

24. (canceled)

25. (canceled)

26. (canceled)

27. A security element according to claim 1, wherein the array of image elements is an array of printed image elements.

28. A security element according to claim 1, wherein the array of image elements is an array of image elements defined by one or more diffraction relief structures, by one or more arrays of nanostructures, or by a discontinuous metal layer.

29. (canceled)

30. (canceled)

31. A security element according to claim 1, wherein the focussing elements have a diameter of less than 20 micrometres.

32. (canceled)

33. A security document having a security element according to claim 1.

34. (canceled)

35. A transfer structure comprising a carrier layer removably attached to a security element according to claim 1.

36. A method of forming a security element comprising:
providing a first layer of a substantially transparent first material having a first refractive index, the first layer having opposing first and second surfaces;
forming in a first region of the first surface of the first layer an array of focusing elements;
providing an optically variable effect generating structure over the first layer in a second region at least partially overlapping the array of focussing elements in the first region; and
providing an array of image elements over the array of focussing elements such that a first image, formed from at least some of the image elements, is displayed to a viewer viewing the image elements via the array of focussing elements of the first layer;
wherein the optically variable effect generating structure is configured to display, in the second region, a second image to the viewer.

37-72. (canceled)
